(19) United States
(12) Patent Application Publication
(10) Pub. No.: US 2019/0155107 A1
(43) Pub. Date: May 23, 2019

(54) LIQUID CRYSTAL DISPLAY DEVICE, AND METHOD FOR PRODUCING LIQUID CRYSTAL DISPLAY DEVICE

(71) Applicant: SHARP KABUSHIKI KAISHA, Sakai City, Osaka (JP)

(72) Inventors: MASANOBU MIZUSAKI, Sakai City (JP); HIROSHI TSUCHIYA, Sakai City (JP); KIYOSHI MINOURA, Sakai City (JP); AKIRA SAKAI, Sakai City (JP)

(21) Appl. No.: 16/313,817

(22) PCT Filed: Jul. 3, 2017
(86) PCT No.: PCT/JP2017/024305

§ 371 Date: Dec. 27, 2018

(30) Foreign Application Priority Data
Jul. 4, 2016 (JP) 2016-132541

(51) Int. Cl. G02F 1/1337; G02F 1/1334

(52) U.S. Cl. CPC G02F 1/133711; G02F 1/1334; C09K 19/542; G02F 2001/133715; G02F 1/133788

(57) ABSTRACT

The present invention provides a liquid crystal display device having excellent visibility outdoors, and a method for producing a liquid crystal display device capable of producing such a liquid crystal display device. The liquid crystal display device includes: a pair of substrates; a liquid crystal layer that is sandwiched between the pair of substrates and contains a liquid crystal material; and an alignment control layer that is in contact with the liquid crystal layer, at least one of the pair of substrates including a retardation layer on its liquid crystal layer side, the alignment control layer aligning the liquid crystal material in a direction horizontal to faces of the substrates, and containing a polymer containing at least a unit derived from a specific first monomer.

### TECHNICAL FIELD

The present invention relates to a liquid crystal display device, and a method for producing a liquid crystal display device. More specifically, the present invention relates to a liquid crystal display device having a retardation layer and an alignment control layer, and a method for producing a liquid crystal display device.

### BACKGROUND ART

A liquid crystal display device is a display device utilizing a liquid crystal composition for display, and in a typical display method for liquid crystal display devices, a liquid crystal panel in which a liquid crystal composition is enclosed between a pair of substrates is irradiated with light from a backlight, and a voltage is applied to the liquid crystal composition to change the alignment of the liquid crystal material, and thus the amount of light transmitting through the liquid crystal panel is controlled. Liquid crystal display devices as described above have advantages of low profile, light weight and low power consumption, so that they are used in electronic devices such as a smartphone, a tablet PC, and a car navigation system.

As another display method for liquid crystal display device, a transverse electric field display mode receives attention, for example, for ease of obtaining the wide viewing angle characteristic. In the transverse electric field display mode, control is performed by rotating the alignment of the liquid crystal material mainly in a plane parallel with faces of substrates. Examples of the transverse electric field display mode include an in-plane switching (IPS) mode, and a fringe field switching (FFS) mode.

In a liquid crystal display device, the alignment of the liquid crystal material in the condition that a voltage is not applied is generally controlled by an alignment film having undergone an alignment treatment. The alignment film is prepared, for example, by applying an alignment film material such as polyamic acid or the like on a substrate, followed by baking. As another method for controlling alignment of a liquid crystal material, a polymer sustained alignment technique (hereinafter, also referred to PSA technique) in which a polymerizable monomer added into the liquid crystal layer is polymerized to form a polymer layer that controls alignment of the liquid crystal material on a face of the alignment film has been investigated (see, for example, Patent Literatures 1 to 3).

Also a technique of forming a retardation layer in a liquid crystal panel has been investigated so as to suppress reflection of outside light and improve the recognizability when the liquid crystal panel is used under the outside light. As a method for producing the retardation layer, for example, polymerization of a polymerizable nematic liquid crystal monomer has been investigated (see, for example, Patent Literature 4).

### CITATION LIST

### Patent Literature

Patent Literature 1: JP 2015-205982 A
Patent Literature 2: JP 2010-033093 A
Patent Literature 3: US 2012/0021141 A1
Patent Literature 4: JP 2007-206241 A

### SUMMARY OF INVENTION

### Technical Problem

In a liquid crystal display device having a retardation layer inside the liquid crystal panel, an alignment film is sometimes formed on the retardation layer so as to align the liquid crystal agent material contained in the liquid crystal layer (for example, see Patent Literature 4). However, forming an alignment film after formation of the retardation layer can reduce the retardation of the retardation layer and deteriorate the visibility.

In view of the above state of the art, it is an object of the present invention to provide a liquid crystal display device having excellent visibility not only indoors but also outdoors, and a method for producing a liquid crystal display device capable of producing such a liquid crystal display device.

### Solution to Problem

The present inventors made investigations concerning a method for suppressing deterioration in retardation of a retardation layer, and have noted the process of forming an alignment film. An alignment film is generally formed by applying an alignment film material containing polyamic acid or the like, and conducting baking, for example, at a temperature of 200° C. or higher. The present inventors have found that when an alignment film is formed on a retardation layer, the retardation of the retardation layer deteriorates by heating at the time of baking.

The present inventors have found that by disposing an alignment control layer instead of a conventional alignment film so as to be in contact with the liquid crystal layer at least on a face of a substrate having a retardation layer on a side of the liquid crystal layer, it is possible to control alignment of the liquid crystal material without forming a conventional alignment film on a face of the substrate. Thus, the present inventors have found that deterioration in retardation of the retardation layer does not occur because the process of baking an alignment film can be omitted.

On the other hand, in a liquid crystal display device not having a conventional alignment film on a face of substrate, the contrast ratio can decrease. Investigations by the present inventors have revealed that a pre-tilt angle is partially formed under the influence of irregularities of faces of substrates (for example, steps arising in the boundary between the region where an electrode is formed, and the region where an electrode is not formed), so that the contrast ratio decreases particularly when the liquid crystal material is aligned in the direction horizontal to faces of substrates. The present inventors also have found that by polymerizing a monomer added into a liquid crystal layer to form an alignment control layer, the influence of the irregularities of faces of substrates is significantly reduced, and formation of a partial pre-tilt angle is prevented, and a high contrast ratio can be obtained.

Further, the present inventors have found that by using a monomer containing a chalconyl group as a material for an alignment control layer that aligns a liquid crystal material in the direction horizontal to faces of substrates, it is possible to polymerize monomer with polarized ultraviolet rays, so that it is possible to form an alignment control layer with lower radiation intensity compared with irradiation with unpolarized light.

One aspect of the present invention may be a liquid crystal display device including: a pair of substrates; a liquid crystal layer that is sandwiched between the pair of substrates and contains a liquid crystal material; and an alignment control layer that is in contact with the liquid crystal layer, at least one of the pair of substrates including a retardation layer on its liquid crystal layer side, the alignment control layer aligning the liquid crystal material in a direction horizontal to faces of the substrates, and containing a polymer containing at least a unit derived from a first monomer represented by the following Chemical formula (A):

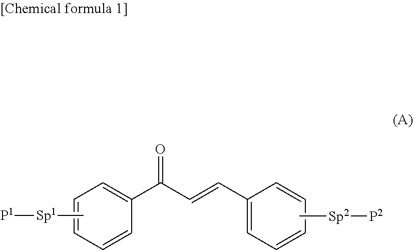

wherein P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Another aspect of the present invention may be a method for producing a liquid crystal display device, including a step of forming a retardation layer in at least one of a pair of substrates, a step of sealing a liquid crystal composition containing a liquid crystal material and at least one type of monomer between the pair of substrates to form a liquid crystal layer, and a step of irradiating the liquid crystal layer with polarized ultraviolet rays to form an alignment control layer by polymerization of the at least one type of monomer at an interface between the pair of substrates and the liquid crystal layer, the at least one type of monomer containing a first monomer represented by the following Chemical formula (A), the alignment control layer aligning the liquid crystal material in a direction horizontal to faces of the substrates,

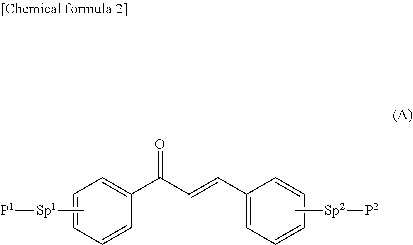

wherein P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Patent Literature 1 discloses a liquid crystal composition containing an alignment control material that is highly compatible to another liquid crystal composition, and having excellent alignment restraining force, and discloses forming an alignment control layer by polymerizing a polymerizable compound contained in the liquid crystal composition. Patent Literature 2 discloses polymerizing a multifunctional monomer having a symmetric structure, mixed into the liquid crystal, and vertically aligning the liquid crystal by the obtained ultraviolet cured product. Patent Literature 3 discloses a composition for alignment of liquid crystal containing a norbornene polymer having photo-reactivity, a binder, a reactive mesogen, and a photo initiator.

However, all of Patent Literatures 1 to 3 lack concrete disclosure about a monomer having a chalconyl group represented by Chemical formula (A), and fail to investigate irradiating the monomer having a chalconyl group with polarized ultraviolet rays. In Patent Literature 2, liquid crystal is vertically aligned by an ultraviolet cured product, however, the liquid crystal display device of the present invention differs from Patent Literature 2 in that the liquid crystal display device has an alignment control layer for aligning the liquid crystal material in the direction horizontal to faces of substrates.

### Advantageous Effects of Invention

The liquid crystal display device of the present invention is excellent in outdoor visibility because reflection of outside light is suppressed by the retardation layer. The alignment control layer containing a polymer containing a unit derived from a specific monomer enables horizontal alignment control of the liquid crystal material.

Since the method for producing a liquid crystal display device according to the aforementioned aspect of the present invention does not include a step of forming a conventional alignment film on the retardation layer, deterioration in retardation of the retardation layer by heating at the time of forming an alignment film is suppressed, and a liquid crystal display device that is excellent in outdoor visibility can be produced.

### BRIEF DESCRIPTION OF DRAWINGS

FIG. 1 is a schematic cross-sectional view of a liquid crystal display device according to Embodiment 1.

FIG. 2 is a schematic plan view of the liquid crystal display device according to Embodiment 1.

FIG. 3 is a schematic view illustrating the process of forming an alignment control layer in a step of forming an alignment control layer.

FIG. 4 is a schematic cross-sectional view of a liquid crystal display device according to Embodiment 2.

FIG. 5 shows photographs of a black state and a light transmission state of Production example 1-1.

FIG. 6 is a schematic cross-sectional view of a liquid crystal display device having an alignment film on a retardation layer.

### DESCRIPTION OF EMBODIMENTS

Hereinafter, embodiments of the present invention are described. The present invention is not limited to the contents described in the following embodiments, but can be appropriately modified in design within the range that satisfies the configuration of the present invention.

### Embodiment 1

### <Liquid Crystal Display Device>

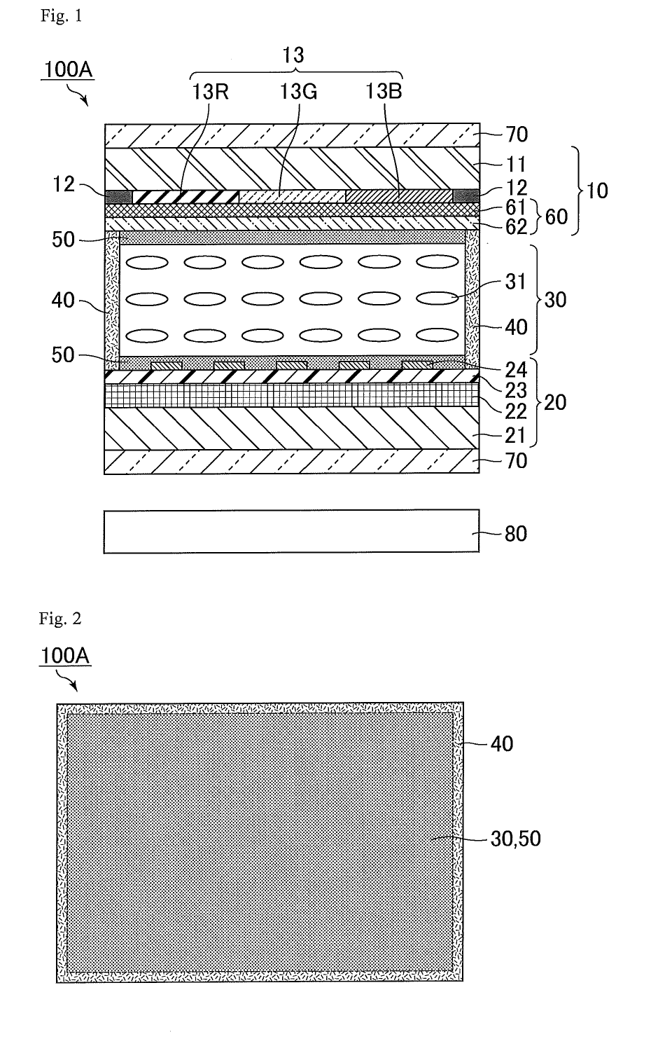

Referring to FIG. 1 and FIG. 2, a liquid crystal display device of Embodiment 1 is described. FIG. 1 is a schematic cross-sectional view of the liquid crystal display device according to Embodiment 1. FIG. 2 is a schematic plan view of the liquid crystal display device according to Embodiment 1. As illustrated in FIG. 1 and

FIG. 2, a liquid crystal display device 100A of Embodiment 1 includes a pair of substrates 10 and 20, a liquid crystal layer 30 sandwiched between the pair of substrates 10 and 20 and containing a liquid crystal material 31, and an alignment control layer 50 being in contact with the liquid crystal layer 30. The substrate 10 has a retardation layer 60 being in contact with the alignment control layer 50 on a side of the liquid crystal layer 30.

By providing the retardation layer 60, it is possible to suppress reflection of outside light in a bright place such as outdoors, and improve the visibility. Further, since the alignment control layer 50 aligns the liquid crystal material 31 in a direction horizontal to faces of substrates, it is not necessary to form a conventional alignment film on the retardation layer (on the side of the liquid crystal layer). Therefore, retardation of the retardation layer will not deteriorate by heating at the time of baking the alignment film. In the present invention, the “alignment control layer” refers to a film capable of controlling alignment of a liquid crystal material, the film being a polymer layer formed at an interface between a liquid crystal layer and a substrate by polymerization of a polymerizable monomer added into the liquid crystal layer, and phase separation from the liquid crystal layer. The “alignment film” means a monolayer film or a multilayer film composed of polyimide, polyamic acid, polyamide, polymaleimide, polysiloxane, polysilsesquioxane, polyphosphazene, or a copolymer thereof, or a film of a silicon oxide formed by oblique deposition, the film being capable of controlling alignment of a liquid crystal material. In a general liquid crystal display device, an alignment film is formed by directly applying (applying, for example, polyimide or the like) or vapor depositing (for example, oblique deposition of a silicon oxide (SiO)) an alignment film material on faces of substrates constituting a display area. The alignment film is not limited to those having undergone an alignment treatment as long as an existing film material such as polyimide is applied.

The liquid crystal display device 100A of Embodiment 1 does not have a conventional alignment film on faces of liquid crystal layer sides of the pair of substrates 10 and 20, and the pair of substrates 10 and 20 are bonded to each other by the sealing member 40. Contact between each of the substrates 10 and 20, and the sealing member 40 without intervention by a conventional alignment film can improve the peel strength.

Examples of the pair of substrates 10, 20 include a combination of an active matrix substrate (TFT substrate) and a color filter (CF) substrate.

As the active matrix substrate, those generally used in the field of liquid crystal display device may be used. In one exemplary configuration of the active matrix substrate in a plan view, on a transparent substrate 21, multiple gate signal lines that are parallel with each other; multiple source signal lines that extend in the direction orthogonal to the gate signal lines, and are parallel with each other; active elements such as thin-film transistors (TFT) that are arranged in correspondence with cross-points between the gate signal lines and the source signal lines; pixel electrodes 24 that are arranged in a matrix state in regions partitioned by the gate signal lines and the source signal lines and so on are disposed. In the case of a transverse electric field display mode, a common line, a common electrode 22 connected to the common line, and so on are further provided. The pixel electrode 24 and the common electrode 22 may be stacked with an insulating layer 23 interposed therebetween. As the TFT, those having channels formed of amorphous silicon, polysilicon, or IGZO (indium-gallium-zinc-oxygen) which is an oxide semiconductor are preferably used.

In a display method of active matrix type, generally, a signal voltage is applied on an electrode through a TFT when a TFT provided for each pixel is ON, and an electric charge charged in the pixel at this time is retained in the period in which the TFT is OFF. The ratio of charged electric charges retained in one frame period (for example, 16.7 ms) is indicated by a voltage holding ratio (VHR). In other words, lower VHR means higher probability of attenuation in the voltage applied to the liquid crystal layer with time, and in the display method of active matrix type, it is required to make VHR high.

As a color filter substrate, those generally used in the field of liquid crystal display device may be used. In one exemplary configuration of the color filter substrate, on a transparent substrate 11, a black matrix 12 is formed into a grid pattern, and a color filter 13 or the like formed inside the grid, namely inside the pixel is provided. The color filter 13 may include a red color filter 13R, a green color filter 13G and a blue color filter 13B. The blue color filter 13B may have a larger thickness than the red color filter 13R or the green color filter 13G. By making the thickness of the blue color filter 13B large, it is possible to reduce the thickness of the liquid crystal layer and to optimize the thickness of the cell. On a face of the color filter 13, an over coat layer (dielectric constant ε=3 to 4) for flattening the bumpy face may be disposed.

At least one of the pair of substrates 10 and 20 has the retardation layer 60 on the side of the liquid crystal layer 30. The retardation layer 60 suppresses reflection of outside light in a bright place such as outdoors, and is capable of improving the visibility of the liquid crystal display device 100A. The liquid crystal display device 100A does not have a conventional alignment film on the retardation layer 60 (on the side of the liquid crystal layer 30). When the retardation layer 60 is formed in a color filter substrate, the retardation layer 60 is formed on the side closer to the liquid crystal layer 30 than the color filter substrate 13. It is preferred that the retardation layer 60 is disposed in the substrate of the side from which outside light enters (viewer's side) for effectively achieving the reflection preventive effect.

The retardation layer 60 may have an in-plane phase difference of 100 to 160 nm. By setting the phase difference within the range of 100 to 160 nm, it is possible to effectively suppress reflection of visible light contained in outside light. Even if the phase difference is less than 100 nm or more than 160 nm, the quantity of the reflected light transmitting through the polarizing plate disposed on the viewer's side of the liquid crystal panel increases, so that sufficient reflection preventive effect is not obtained. The in-plane phase difference Re can be calculated by the following Formula (1).

Re=(nx−ny)×d (1)

nx: refractive index of slow axis in plane of retardation layer 60

ny: refractive index of fast axis in plane of retardation layer 60

d: thickness of retardation layer 60

The retardation layer 60 may be a laminate of an alignment layer 61 and a polymer 62 of liquid crystal monomer. The alignment layer 61 controls alignment of a liquid crystal monomer that constitutes the polymer 62 to be laminated. By laminating the liquid crystal monomer on the alignment layer 61, and polymerizing the monomer, it is possible to fix the liquid crystal monomer in a predetermined alignment orientation, and to form a retardation layer having a desired phase difference. On the other hand, the retardation layer 60 which is a laminate of the alignment layer 61 and the polymer 62 of a liquid crystal monomer is poor in heat resistance, and is susceptible to deterioration in retardation by heating. Therefore, when the retardation layer 60 is formed of a laminate of the alignment layer 61 and the polymer 62 of a liquid crystal monomer, it is possible to suppress deterioration in retardation more effectively by not forming an alignment film on the retardation layer 60.

Examples of the alignment layer 61 include a monolayer film or a multilayer film composed of polyimide, polyamic acid, polyamide, polymaleimide, polysiloxane, polysilsesquioxane, polyphosphazene, or a copolymer thereof, or a film of a silicon oxide formed by oblique deposition. It is preferred that the alignment layer 61 has undergone an alignment treatment. The alignment treatment method is not particularly limited, and a rubbing method, a photo-alignment treatment or the like can be used.

When the alignment layer 61 has undergone a photo-alignment treatment, it is preferred that the alignment layer 61 contains a polymer having a photoreactive functional group. The photoreactive functional group refers to a functional group that presents a functional change such as, for example, dimerization (formation of dimer), isomerization, photo-Fries rearrangement, or decomposition by irradiation with light (electromagnetic wave) such as ultraviolet light or visible light, and is capable of expressing alignment restraining force. Concrete examples of the photoreactive functional group include an azobenzene group, a chalcone group, a cinnamate group, a coumarin group, a tolan group, and a stilbene group.

The liquid crystal monomer is a polymerizable monomer having anisotropy of refractive index. The liquid crystal monomer may be a monomer having a phase difference by itself, or may be a monomer capable of expressing a phase difference when the liquid crystal monomer is polymerized on the alignment layer 61 having undergone an alignment treatment. The phase difference of the liquid crystal monomer itself, or the in-plane phase difference of the retardation layer 60 obtained by polymerizing the liquid crystal monomer on the alignment layer 61 is preferably 100 to 160 nm. By polymerizing the liquid crystal monomer, deterioration in phase difference caused by thermal fluctuation is suppressed, and stability such as temperature stability can be improved.

The liquid crystal monomer may be an acryl monomer or a methacryl monomer. The acryl monomer has an acryl group as a polymerizable group. The methacryl monomer has a methacryl group as a polymerizable group. When the liquid crystal monomer is an acryl monomer, the reaction speed is advantageously high. When the liquid crystal monomer is a methacryl monomer, the glass transition point is high, so that it is possible to decrease the temperature dependency of the phase difference.

Examples of the liquid crystal monomer include compounds represented by the following Chemical formulas (E-1) to (E-14).

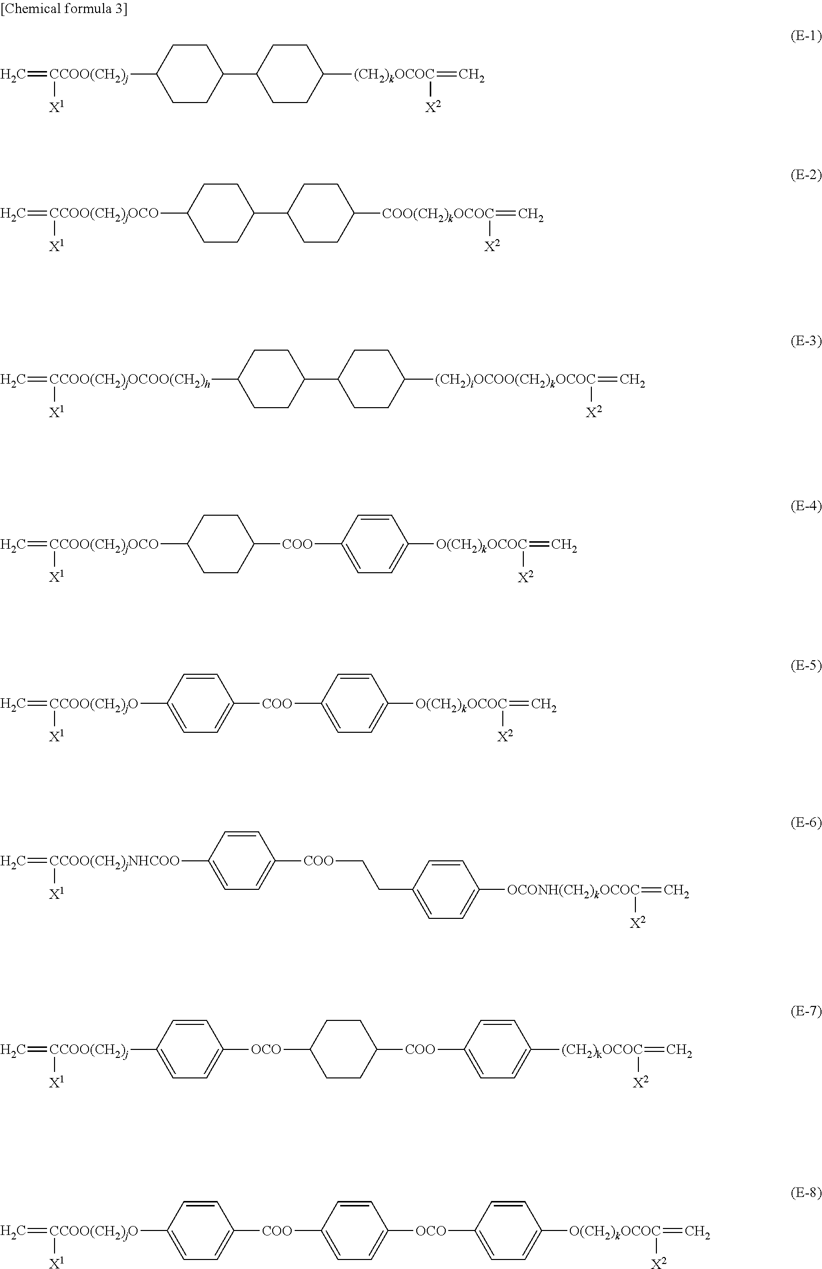

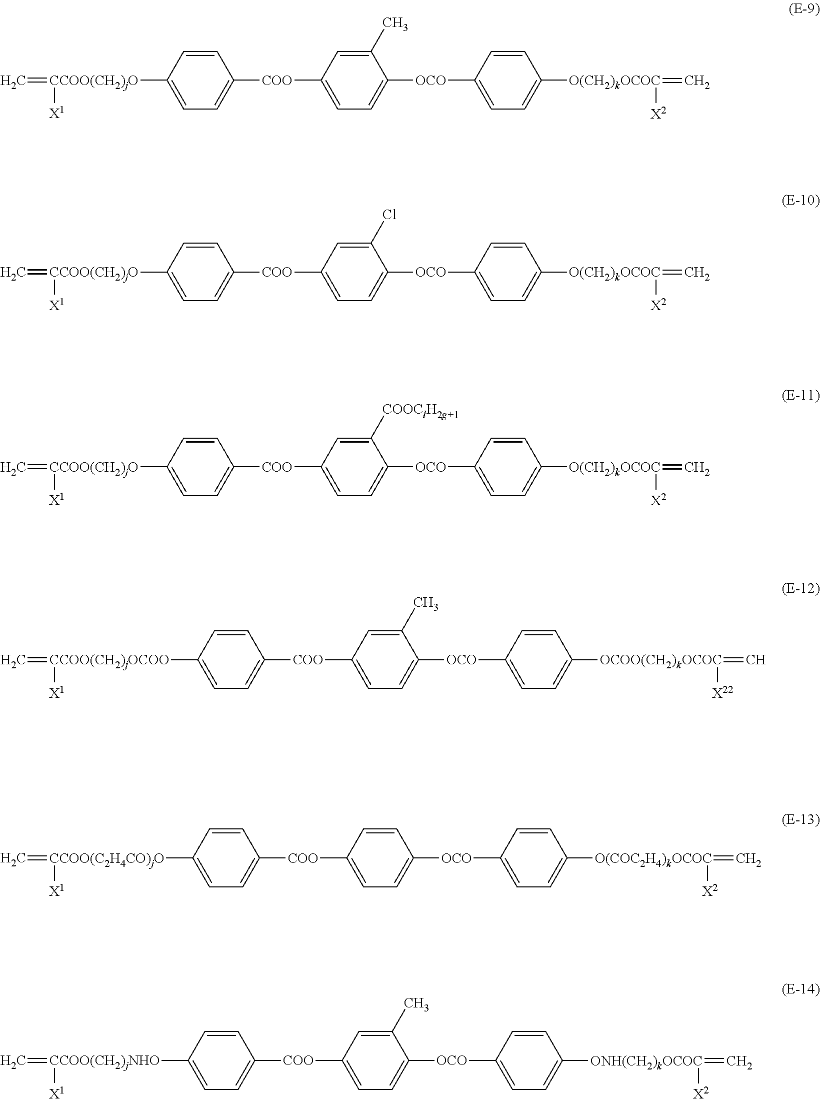

In the formulas, X¹ and X² are the same as or different from each other, and each represent a hydrogen atom or a methyl group, g is an integer of 1 to 18, h and i are the same as or different from each other, and each represent an integer of 1 to 18, and j and k are the same as or different from each other, and each represent an integer of 1 to 12.

In the pair of substrates 10, 20, both the color filter 13 and the active matrix may be formed on either one of the substrates. While the form in which the substrate 10 has the retardation layer 60 has been described in Embodiment 1, both of the pair of substrates 10 and 20 may have the retardation layer 60.

As shown in FIG. 2, for example, the sealing member 40 is disposed to surround the periphery of the liquid crystal layer 30 in a plan view. Since the liquid crystal display device 100A does not have an alignment film on faces of the substrates 10 and 20, each of the substrates 10 and 20, and the sealing member 40 are in direct contact with each other, so that peel strength is high. The sealing member 40 may be cured by light such as ultraviolet rays, or may be cured by heat, or may be curedd by both light and heat. The sealing member 40 may contain an epoxy resin or a (meth)acryl resin, for example. The sealing member 40 may contain an inorganic filler, an organic filler or a curing agent. As the sealing member 40, for example, Photolec available from Sekisui Chemical Co., Ltd. may be used.

The sealing member 40 may have a width in a plan view of 0.4 mm or more and 5 mm or less. A more preferred lower limit of the width of the sealing member 40 is 0.6 mm, and a more preferred upper limit is 4 mm or less, and a further preferred upper limit is 2 mm. Since the peel strength between each of the substrates 10 and 20, and the sealing member 40 is high in the liquid crystal display device of Embodiment 1, the substrate 10 and the substrate 20 can be bonded to each other adequately even when the width of the sealing member is, for example, 1.0 mm or less.

The liquid crystal layer 30 contains the liquid crystal material 31. As a voltage of a threshold or higher of the liquid crystal material 31 is applied to the liquid crystal layer 30, the alignment of the liquid crystal material 31 changes, and thus the quantity of light transmitting through the liquid crystal panel can be controlled. Unlike the liquid crystal monomer as described above, the liquid crystal material 31 generally does not have a polymerizable group. The liquid crystal material 31 is thermotropic liquid crystal, and is preferably, a liquid crystal material exhibiting a nematic phase (nematic liquid crystal). The liquid crystal material is preferably the one of which phase transits to the isotropic phase from the nematic phase at a certain critical temperature (nematic phase-isotropic phase transition point (T_{NI})) or higher as the temperature is elevated. It is preferred that the liquid crystal layer 40 exhibits a nematic phase under a service environment (for example, −40° C. to 90° C.) of the liquid crystal display device. Examples of the temperature of the nematic phase-isotropic phase transition point of the liquid crystal material include, but are not limited to, 70 to 110° C. When the liquid crystal material contains a liquid crystal compound having an alkenyl group, the aforementioned T_{NI} is T_{NI} of the liquid crystal material containing the liquid crystal compound having an alkenyl group.

The aforementioned liquid crystal material may be those having a negative value of anisotropy of dielectric constant (Δε) defined by the following formula, or those having a positive value of anisotropy of dielectric constant (Δε). The liquid crystal material may have negative anisotropy of dielectric constant, or may have positive anisotropy of dielectric constant. As the liquid crystal material having negative anisotropy of dielectric constant, for example, those having Δε of −1 to −20 can be used. As the liquid crystal material having positive anisotropy of dielectric constant, for example, those having Δε of 1 to 20 can be used. Further, the liquid crystal layer 30 may contain a liquid crystal material not having polarity, namely a liquid crystal layer having Δε of substantially 0 (neutral liquid crystal material). Examples of the neutral liquid crystal material include a liquid crystal material having an alkene structure. Δε=(Dielectric constant along long axis)−(Dielectric constant along short axis)

From the view point of keeping high VHR, it is preferred that the liquid crystal material has positive anisotropy of dielectric constant. On the other hand, when the display mode of the liquid crystal display device 100A is a transverse electric field display mode, the liquid crystal material preferably has negative anisotropy of dielectric constant because an excellent contrast ratio is obtained.

The liquid crystal material may contain a liquid crystal compound having an alkenyl group. By containing a liquid crystal compound having an alkenyl group, it is possible to improve the responsibility of the liquid crystal material, and to improve the speed. On the other hand, a liquid crystal compound having an alkenyl group is poor in light resistance, so that it can decompose by irradiation with ultraviolet rays to cause deterioration in VHR. In Embodiment 1, the alignment control layer 50 contains a polymer containing a unit derived from a first monomer represented by Chemical formula (A), and the first monomer has a chalconyl group, and expresses an alignment restraining force by polarized ultraviolet rays which are the ultraviolet light only in a uniaxial direction. Therefore, it is possible to largely reduce the intensity of the ultraviolet rays applied to the liquid crystal layer 30 as compared with unpolarized light. Therefore, the problem of reliability such as deterioration in VHR is less likely to occur even when the liquid crystal compound having an alkenyl group is introduced into the liquid crystal material.

The liquid crystal compound having an alkenyl group may be a compound represented by any one of the following Chemical formulas (B-1) to (B-4).

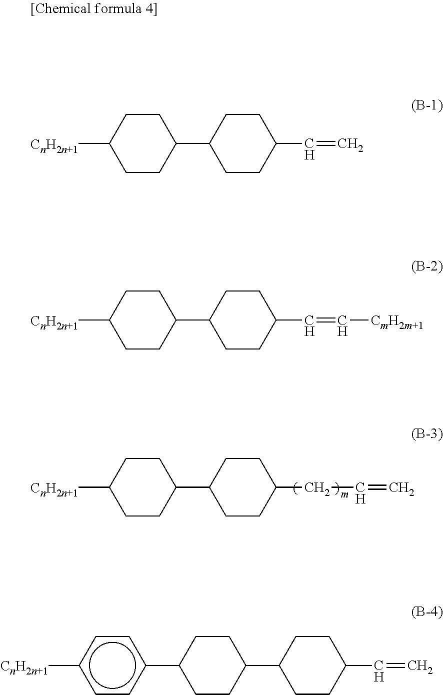

In the formulas, m and n are the same as or different from each other, and each represent an integer of 1 to 6.

Concrete examples of the liquid crystal compound having an alkenyl group include a compound represented by the following Chemical formula (B-1-1).

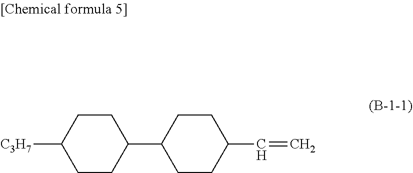

As shown in FIG. 2, the alignment control layer 50 is disposed in a region surrounded by the sealing member 40 in a plan view. The alignment control layer 50 is disposed to be in contact with the liquid crystal layer 30, and the liquid crystal material 31 in the liquid crystal layer 30 is aligned in a direction horizontal to faces of the substrates 10 and 20. Regarding the alignment control layer 50, alignment of the liquid crystal material in the condition that a voltage of a threshold or higher of the liquid crystal material is not applied to the liquid crystal layer 30 is controlled by the alignment control layer 50. Aligning the liquid crystal material 31 in the direction horizontal to faces of the substrates 10 and 20 means that a pre-tilt angle of the liquid crystal material with respect to faces of the substrates 10 and 20 is 10° or less. It is more preferred that the pre-tilt angle is 3° or less. The pre-tilt angle refers to an angle formed by a long axis of the liquid crystal material with respect to a face of substrate at an applied voltage to the liquid crystal layer 30 of less than the threshold voltage (including no application of voltage), and a face of substrate is 0°, and a normal of substrate is 90°.

The alignment control layer 50 contains at least a polymer containing a unit derived from a first monomer represented by Chemical formula (A).

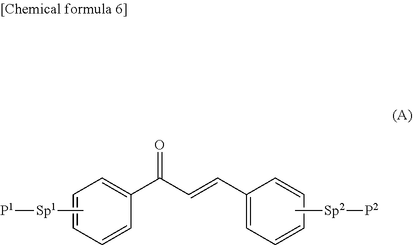

In the formula, P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Having a methacryloyloxy group or a methacryloylamino group as a polymerizable group increases the dose of the polarized ultraviolet rays at the time of forming an alignment control layer, however, the alignment control layer once formed is capable of keeping high alignment stability for a long term. On the other hand, having an acryloyloxy group, an acryloylamino group, a vinyl group, or a vinyloxy group as a polymerizable group provides a horizontal alignment control layer capable of sufficiently controlling the alignment orientation of the liquid crystal material even with a relatively small dose of the polarized ultraviolet rays, so that it is possible to obtain a liquid crystal display device having a high contrast ratio with a smaller dose. Further, since an acryloyloxy group completely becomes aliphatic after polymerization, it is possible to form an alignment control layer having excellent reliability.

The first monomer represented by Chemical formula (A) has a chalconyl group. The chalconyl group is capable of expressing an alignment restraining force by absorbing polarized ultraviolet rays. Irradiation with polarized ultraviolet rays can lower the intensity of light irradiation applied to the liquid crystal layer 30, compared with irradiation with unpolarized light because only light in the monoaxial direction is applied. Expression of the alignment restraining force by the first monomer enables the alignment control layer 50 to align the liquid crystal material in the direction horizontal to faces of substrates. Also, the first monomer has two polymerizable groups, and polymerizes by irradiation with light such as ultraviolet rays or heating to form a polymer. The phase of the polymer is separated from the liquid crystal layer, so that the alignment control layer 50 is formed.

Concrete examples of the first monomer include monomers represented by the following Chemical formula (A-1) or (A-2).

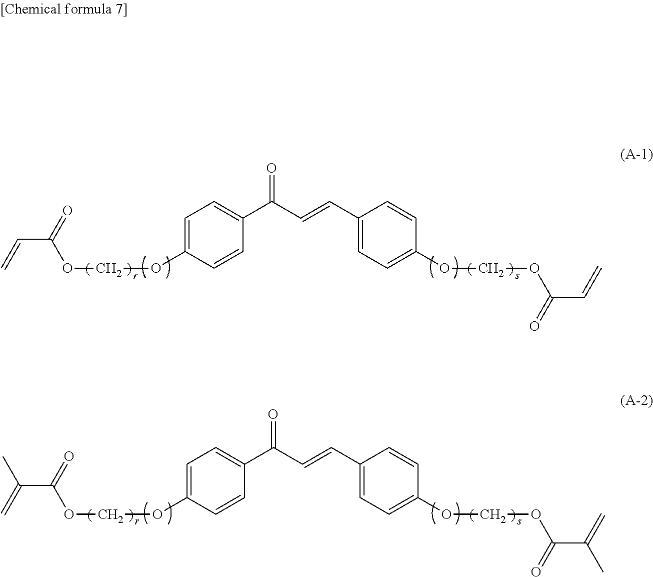

In the formula, r and s are the same as or different from each other, and each represent an integer of 1 to 6.

More concrete examples of the first monomer include monomers represented by any one of the following Chemical formulas (A-1-1), and (A-2-1) to (A-2-4).

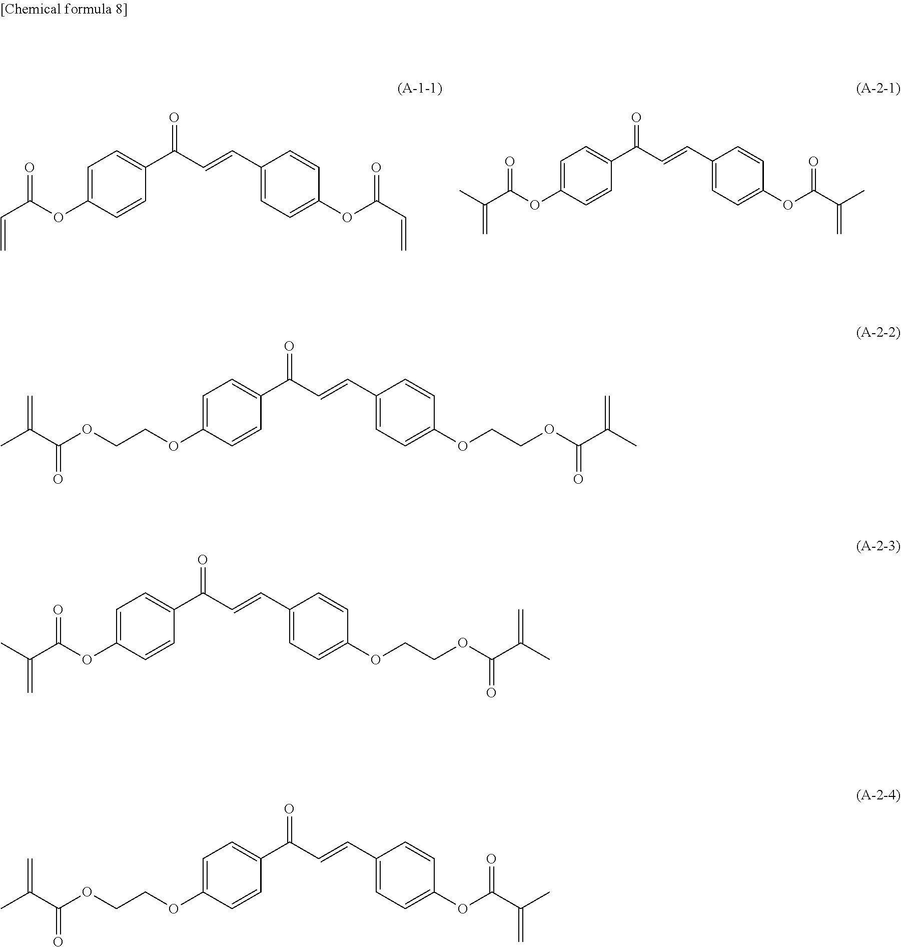

Since radicals are formed by photo Fries rearrangement in the monomers represented by Chemical formulas (A-1-1) and (A-2-1), the monomers polymerize without necessity of a polymerization initiator or a polymerization initiation monomer, and can form the alignment control layer 50. In the monomers represented by Chemical formulas (A-2-2), (A-2-3), and (A-2-4), an alkyl group is introduced between a chalconyl group and a polymerizable group, and the molecular structure is flexible. Therefore, the alignment control layer 50 having more excellent alignability can be obtained.

The aforementioned polymer may further contain a unit derived from a second monomer represented by the following Chemical formula (C). The second monomer is a polymerization initiation monomer, and has a structure of generating a radical by a hydrogen abstraction reaction caused by light irradiation.

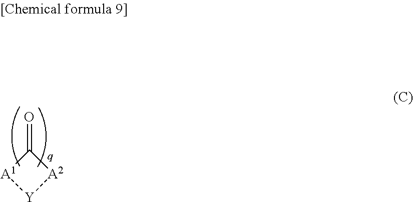

In the formula, A¹ and A² are the same as or different from each other, and each represent a benzene ring, a biphenyl ring, a linear or branched C1-C12 alkyl group, or a linear or branched C1-C12 alkenyl group,

either one of A¹ and A² is a benzene ring or a biphenyl ring,

at least one selected from A¹ and A² contains an -Sp³-P³ group,

a hydrogen atom in each of A¹ and A² may be replaced by an -Sp^{a}-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group,

two adjacent hydrogen atoms in each of A¹ and A² may each be replaced by a linear or branched C1-C12 alkylene group, a linear or branched C1-C12 alkenylene group, or a linear or branched C1-C12 aralkyl group to form a cyclic structure,

a hydrogen atom of an alkyl group, an alkenyl group, an alkylene group, an alkenylene group, or an aralkyl group of each of A¹ and A² may be replaced by an -Sp^{a}-P³ group, a —CH₂- group of an alkyl group, an alkenyl group, an alkylene group, an alkenylene group or an aralkyl group of each of A¹ and A² may be replaced by an —O— group, an —S— group, an —NH— group, a —CO— group, a —COO— group, an —OCO— group, an —O—COO— group, an —OCH₂— group, a —CH₂O— group, an —SCH₂—group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,

P³ represents a polymerizable group,

Sp^{a} represents a linear, branched, or cyclic C1-C6 alkylene group, a linear, branched, or cyclic C1-C6 alkyleneoxy group, or a direct bond,

q is 1 or 2,

the dotted line part connecting A¹ and Y, and the dotted line part connecting A² and Y indicate that a bond via Y may exist between A¹ and A², and

Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

A polymerizable group P³ contained in the compound represented by Chemical formula (C) may be a radical polymerizable group. It is preferred that the polymerizable group P³ is an acryloyloxy group, a methacryloyloxy group, an acryloylamino group, a methacryloylamino group, a vinyl group, or a vinyloxy group.

Concrete examples of the second monomer include compounds represented by the following Chemical formulas (C-1) to (C-8).

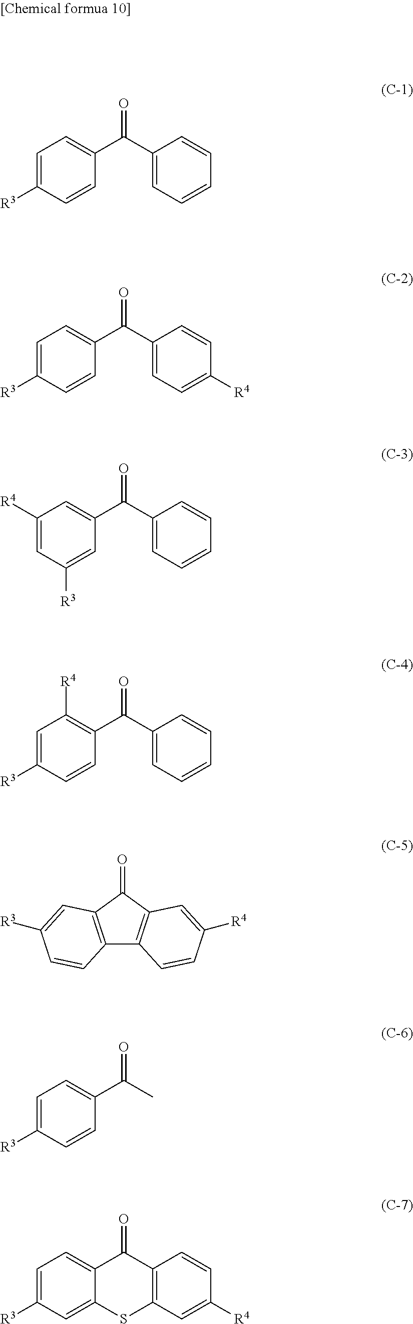

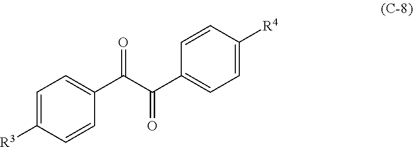

In the formulas, R³ and R⁴ are the same as or different from each other, and each represent an -Sp⁶-P⁶ group, a hydrogen atom, a —CN group, an —NO₂ group, an —NCO group, an —NCS group, an —OCN group, an —SCN group, an —SF₅ group, a linear or branched C1-C12 alkyl group, or a linear or branched C1-C12 aralkyl group, or a phenyl group,

at least one selected from R³ and R⁴ contains an -Sp⁶-P⁶ group,

P⁶ represents a radical polymerizable group,

Sp⁶ represents a linear, branched, or cyclic C1-C6 alkylene group, a linear, branched, or cyclic C1-C6 alkyleneoxy group, or a direct bond,

when at least one selected from R³ and R⁴ is a C1-C12 alkyl group, a linear or branched C1-C12 aralkyl group, or a phenyl group, a hydrogen atom in each of R³ and R⁴ may be replaced by a fluorine atom, a chlorine atom, or an -Sp⁶-P⁶ group, and

a —CH₂— group of each of R³ and R⁴ may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or an —OCO—CH═CH— group as long as an oxygen atom, sulfur atom, and a nitrogen atom are not adjacent to one another.

It is preferred that the radical polymerizable group P⁶ contained in the compounds represented by Chemical formulas (C-1) to (C-8) is an acryloyloxy group, a methacryloyloxy group, an acryloylamino group, a methacryloylamino group, a vinyl group, or a vinyloxy group.

More concrete examples of the second monomer include a compound represented by the following Chemical formula (C-2-1) or (C-2-2).

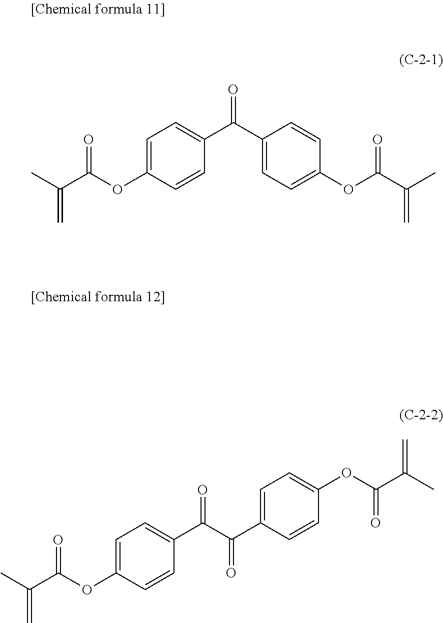

The aforementioned polymer may further contain a unit derived from a third monomer represented by the following Chemical formula (D). The third monomer is a polymerization initiation monomer, and has a structure of generating a radical by a self cleavage reaction caused by light irradiation.

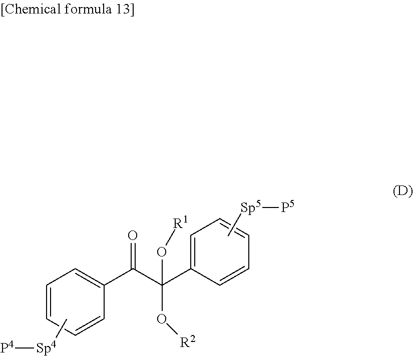

In the formula, R¹ and R² are the same as or different from each other, and each represent a linear or branched C1-C4 alkyl group, or a linear or branched C1-C4 alkenyl group,

P⁴ and P⁵ are the same as or different from each other, and each represent an acryloyloxy group, a methacryloyloxy group, an acryloylamino group, a methacryloylamino group, a vinyl group, or a vinyloxy group, and

Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

Concrete examples of the third monomer include compounds represented by the following Chemical formula (D-1), and more concrete compounds include compounds represented by the following Chemical formula (D-1-1).

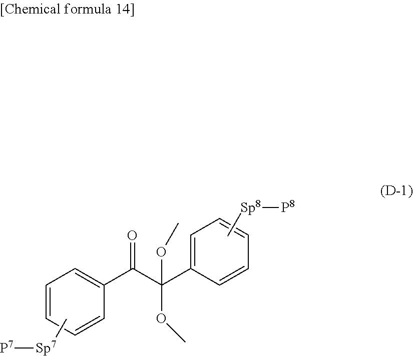

In the formula, P⁷ and P⁸ are the same as or different from each other, and each represent an acryloyloxy group, a methacryloyloxy group, an acryloylamino group, a methacryloylamino group, a vinyl group, or a vinyloxy group, and

Sp⁷ and Sp⁸ are the same as or different from each other, and each represent a linear, branched, or cyclic C1-C6 alkylene group, a linear, branched, or cyclic C1-C6 alkyleneoxy group, or a direct bond.

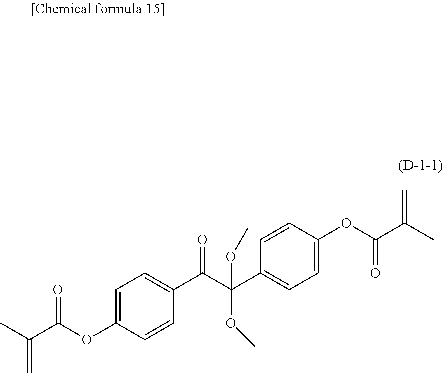 [SMILES: C=C(C)C(=O)Oc1ccc(C(=O)C(OC)(OC)c2ccc(OC(=O)C(=C)C)cc2)cc1]

Using the second monomer or the third monomer which is a polymerization initiation monomer can improve the polymerization speed of the first monomer, so that it is possible to reduce the intensity of light irradiation applied to the liquid crystal layer 30 at the time of forming the alignment control layer 50. Therefore, even when the adding amount of the liquid crystal compound having an alkenyl group having poor light resistance is increased so as to lower the viscosity of the liquid crystal material, it is possible to achieve high speed responsibility while suppressing deterioration in VHR. Since both the second monomer and the third monomer have a polymerizable group, the monomers are likely to be incorporated into an alignment control layer at the time of forming the alignment control layer, and thus are less likely to remain in the liquid crystal layer as impurities. Therefore, they are less likely to cause deterioration in voltage holding ratio (VHR). Even when the second monomer and the third monomer are added to the liquid crystal composition, it is possible to form the alignment control layer 50 by light irradiation, and to conduct a sufficient horizontal alignment control.

A polarizing plate (linear polarizer) 70 may be disposed on each of the pair of substrates 10, 20 on the side opposite to the liquid crystal layer 30. The polarizing plate 70 is typically produced by adsorbing and aligning an anisotropic material such as an iodine complex exhibiting dichroism on a polyvinyl alcohol (PVA) film. Typically, a protective film such as a triacetyl cellulose film is laminated on both faces of the PVA before practical application. Between the polarizing plate 70 and the pair of substrates 10, 20, an optical film such as a retardation film may be disposed.

As shown in FIG. 1, in the liquid crystal display device of Embodiment 1, a backlight 80 is disposed on the side of the back face of the liquid crystal panel. The liquid crystal display device having such a configuration is generally called a transmissive liquid crystal display device. The backlight 80 is not particularly limited as long as it emits light including visible light, and may emit light including only visible light, or may emit light including both visible light and ultraviolet light.

The liquid crystal display device of Embodiment 1 is made up of multiple members including an external circuit such as tape carrier package (TCP) or printed circuit board (PCB); an optical film such as a viewing angle extending film or a luminance improving film; and bezel (frame) besides the liquid crystal panel and the backlight 80, and a particular member may be incorporated into another member. The members other than the members that have been already described are not particularly limited, and those generally used in the field of liquid crystal display device can be used. Therefore, the description of such members is omitted.

The liquid crystal display device 100A may be in a transverse electric field display mode. Examples of the transverse electric field display mode include an IPS mode, an FFS mode, and an electrically controlled birefringence (ECB) mode.

In the FFS mode, at least one of the substrates 10 and 20 is provided with a structure including a planar electrode, a slit electrode, and an insulating film disposed between the planar electrode and the slit electrode (FFS electrode structure), and an oblique electric field (fringe electric field) is formed in the liquid crystal layer 30. Typically, a slit electrode, an insulating film, and a planar electrode are disposed in sequence from the liquid crystal layer 30 side. As the slit electrode, for example, the one having a linear opening as a slit, the entire periphery of the slit being surrounded by the electrode, or the one in a comb shape having multiple comb tooth parts in which a linear cut disposed between comb tooth parts constitutes a slit can be used.

In the IPS mode, for example, a pair of interdigitated electrodes are provided on at least either of the substrates 10 and 20, and a transverse electric field is formed in the liquid crystal layer 30. As the pair of interdigitated electrodes, for example, a pair of electrodes each having multiple comb tooth portions, and arranged in such a manner that the comb tooth portions mutually mesh with each other can be used.

In the ECB mode, for example, either one of the substrates 10 and 20 is provided with a pixel electrode, and the other of the substrates is provided with a counter electrode, and a liquid crystal material having positive anisotropy of dielectric constant is used. By the voltage applied between the pixel electrode and the counter electrode, the retardation of the liquid crystal material is varied, and thus transmission or non-transmission of light is controlled.

### <Method for Producing Liquid Crystal Display Device of Embodiment 1>

A method for producing a liquid crystal display device of Embodiment 1 is described. A method for producing a liquid crystal display device of Embodiment 1 includes a step of forming a retardation layer in at least one of a pair of substrates, a step of sealing a liquid crystal composition containing a liquid crystal material and at least one type of monomer between the pair of substrates to form a liquid crystal layer, and a step of irradiating the liquid crystal layer with polarized ultraviolet rays to form an alignment control layer by polymerization of the at least one type of monomer at an interface between the pair of substrates and the liquid crystal layer.

Hereinafter, while the steps are described in more detail, the members are as described above, and thus the description thereof is omitted.

When the retardation layer is formed in a color filter substrate in the step of forming a retardation layer, the retardation layer is formed after forming, for example, a black matrix, a color filter, and an over coat layer. When the retardation layer is formed in a TFT substrate, the retardation layer is formed after forming, for example, a common electrode, a pixel electrode, a TFT, and various signal lines.

In the step of forming a retardation layer, an alignment layer may be formed on a face of at least one of the substrates, a composition containing a liquid crystal monomer may be applied on the alignment layer, and the liquid crystal monomer may be polymerized. The alignment layer is formed, for example, on a face of at least one of the pair of substrates, by applying an alignment layer composition containing polyimide, polyamic acid, polyamide, polymaleimide, polysiloxane, polysilsesquioxane, or polyphosphazene, or obliquely depositing an alignment layer composition containing a silicon oxide, and then conducting baking or the like. The alignment layer composition may contain a polymer having a photoreactive functional group as described above.

It is preferred that the alignment layer 61 undergoes an alignment treatment. The alignment treatment method is not particularly limited, and a rubbing method, a photo-alignment treatment or the like can be used. The alignment treatment may be conducted so that the orientation in which the alignment layer aligns the liquid crystal material, and the orientation in which the alignment control layer aligns the liquid crystal material are parallel with each other.

Polymerization of the liquid crystal monomer is conducted, for example, by radiation with light such as visible light or ultraviolet rays. Since polymerization of the liquid crystal monomer is conducted by bulk polymerization (mass polymerization) that does not use a solvent or conducted in the condition of high concentration of the liquid crystal monomer, it is expected that the degree of polymerization of the liquid crystal monomer is low, for example, 30000 or less by a weight average molecular weight. Therefore, when a retardation layer is formed by laminating a polymer of a liquid crystal monomer on the alignment layer, the retardation layer, in particular, has low heat resistance, and is susceptible to deterioration in retardation under heating, for example, at 200° C. or higher.

The liquid crystal monomer may be an acryl monomer or a methacryl monomer.

In the step of forming a liquid crystal layer, the liquid crystal composition can be sealed in such a manner that the liquid crystal composition is sandwiched between the pair of substrates by the sealing member, and the sealing member may not be cured. Hardening of the sealing member may be carried out separately or at the same time with the step of forming an alignment control layer as will be described later. As described above, the sealing member may be cured by light such as ultraviolet rays, or may be cured by heat, or may be cured by both light and heat.

The liquid crystal layer can be formed by filling the space between the pair of substrates with the liquid crystal composition, for example, by vacuum injection or one drop filling. When the vacuum injection is employed, a liquid crystal layer is formed by conducting application of the sealing member, pasting together of the pair of substrates, curing of the sealing member, injection of the liquid crystal composition, and sealing of the injection port in this order. When the one drop filling is employed, a liquid crystal layer is formed by conducting application of the sealing member, dropping of the liquid crystal composition, pasting together of the pair of substrates, and curing of the sealing member in this order.

As described above, the liquid crystal material may have negative anisotropy of dielectric constant, or may have positive anisotropy of dielectric constant. The liquid crystal material may contain a liquid crystal compound having an alkenyl group. The liquid crystal compound having an alkenyl group may be a compound represented by any one of Chemical formulas (B-1) to (B-4).

The at least one type of monomer contains the first monomer represented by the following Chemical formula (A). The first monomer represented by the following Chemical formula (A) has a chalconyl group, and is capable of expressing an alignment restraining force by absorbing polarized ultraviolet rays. Irradiation with polarized ultraviolet rays can lower the intensity of light irradiation applied to the liquid crystal layer, compared with irradiation with unpolarized light because light made up of only light in the monoaxial direction is applied.

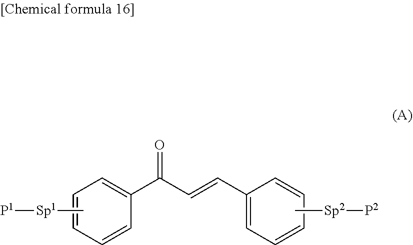

In the formula, P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

Concrete examples of the first monomer include monomers represented by Chemical formula (A-1) or (A-2). More concrete examples of the first monomer include monomers represented by any one of Chemical formulas (A-1-1), and (A-2-1) to (A-2-4).

A first monomer content in the liquid crystal composition may be 0.1% by weight or more, and 10% by weight or less.

The at least one type of monomer may contain the second monomer represented by Chemical formula (C). Concrete examples of the second monomer include compounds represented by Chemical formulas (C-1) to (C-8). More concrete examples of the second monomer include a compound represented by Chemical formula (C-2-1).

A second monomer content in the liquid crystal composition may be 0.01% by weight or more, and 0.5% by weight or less. The mixing ratio of the first monomer and the second monomer may be 5:1 to 1000:1.

The at least one type of monomer may contain the third monomer represented by Chemical formula (D). Concrete examples of the third monomer include compounds represented by the following Chemical formula (D-1), and more concrete compounds include compounds represented by the following Chemical formula (D-1-1).

A third monomer content in the liquid crystal composition may be 0.01% by weight or more, and 0.5% by weight or less. The mixing ratio of the first monomer and the third monomer may be 5:1 to 1000:1.

The higher the second monomer content or the third monomer content in the liquid crystal composition, or the higher the mixing ratio of the second monomer or the third monomer to the first monomer, the higher the monomer polymerization speed of the monomer, and the dose of the polarized ultraviolet rays can be reduced. Therefore, it is possible to suppress deterioration in VHR by irradiation with polarized ultraviolet rays. On the other hand, as the second monomer content or mixing ratio or the third monomer content or mixing ratio increases, the alignment in the horizontal alignability decreases, so that the contrast ratio can bedecreased. Therefore, in order to improving the alignability of the alignment control layer, it is desired to lower the second monomer content or mixing ratio or the third monomer content or mixing ratio. The second monomer and the third monomer may be used together.

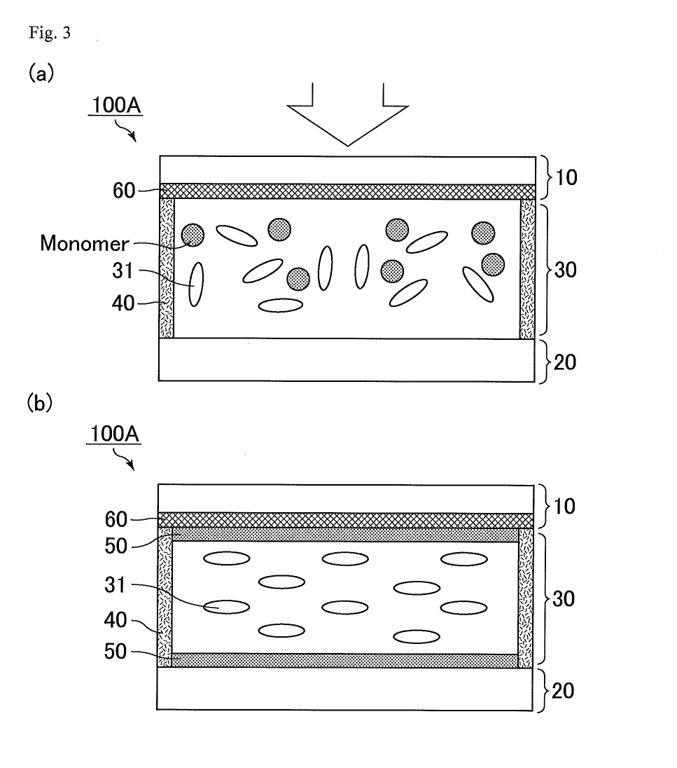

Hereinafter, the step of forming an alignment control layer is described by referring to FIG. 3. FIG. 3 is a schematic view illustrating the process of forming an alignment control layer in a step of forming an alignment control layer. FIG. 3(a) illustrates monomers before polymerization, and FIG. 3(b) illustrates monomers after polymerization. In FIG. 3(a), the arrow indicates polarized ultraviolet rays. As shown in FIG. 3(a), by irradiating the liquid crystal layer 30 with polarized ultraviolet rays, the at least one type of monomer polymerizes, and the alignment control layer 50 is formed at interfaces between the substrates 10 and 20, and the liquid crystal layer 30 as shown in FIG. 3(b). The alignment control layer 50 aligns the liquid crystal material in a direction horizontal to faces of the substrates.

The polarized ultraviolet rays may have a wavelength of 200 nm or more and 430 nm or less. A more preferred lower limit of the wavelength is 250 nm, and a more preferred upper limit is 380 nm. The dose of the polarized ultraviolet rays may be 0.3 J/cm² or more and 20 J/cm² or less. A more preferred lower limit of the dose is 1 J/cm², and a more preferred upper limit is 5 J/cm². It is preferred that the polarized ultraviolet rays are linear polarized ultraviolet rays.

In the step of forming an alignment control layer, polarized ultraviolet rays may be applied while the liquid crystal layer is heated at a temperature of a nematic phase-isotropic phase transition point of the liquid crystal material or higher and lower than 200° C. By heating the liquid crystal layer at a temperature of a nematic phase-isotropic phase transition point (T_{NI}) of the liquid crystal material or higher, it is possible to prevent the condition of the applied polarized ultraviolet rays from changing by the liquid crystal material in the liquid crystal layer, and thus it is possible to produce a liquid crystal display device having a high degree of alignment (high contrast ratio). It is preferred that the heating temperature is higher than the nematic phase-isotropic phase transition point of the liquid crystal material by 3° C. or more. An upper limit of the heating temperature is, for example, lower than 200° C. from the view point of suppressing deterioration in retardation of the retardation layer. A more preferred upper limit of the heating temperature is, for example, 140° C. from the view point of suppressing the thermal degradation of the liquid crystal material contained in the liquid crystal layer as much as possible. The conditions including heating time and heating means are not particularly limited. The nematic phase-isotropic phase transition point of the liquid crystal material can be measured, for example, by the differential scanning calorimetry (DSC), or by a method of enclosing the liquid crystal material in a capillary and directly observing the temperature dependence.

Since the method for producing a liquid crystal display device of Embodiment 1 does not have a step of forming a conventional alignment film on faces of a pair of substrates prior to the step of forming a retardation layer and the step of forming a liquid crystal layer, deterioration in retardation of the retardation layer due to heating at the time of forming an alignment film does not occur. Also, the pair of substrates are bonded to each other in such a manner that each substrate is in direct contact with the sealing member without intervention by an alignment film. Further, by having the step of forming an alignment control layer after the step of forming a liquid crystal layer, the pair of substrates sandwiching the liquid crystal layer are bonded to each other by the sealing member, and an alignment control layer can be formed in a region surrounded by the sealing member in a plan view.

The above step is followed by a step of pasting a polarizing plate, and a step of attaching a controlling unit, a power unit, a backlight and so on to complete the liquid crystal display device of Embodiment 1.

When the liquid crystal display device is in a normally black mode, for example, a pair of polarizing plates are arranged on the outer sides of the pair of substrates in a crossed Nicols relationship so that the absorption axes intersect each other at right angles, and the polarizing plates are arranged so that the absorption axis of the polarizing plates and the irradiation axis of the polarized ultraviolet rays form an angle of 0° or 90°. In the condition that a voltage of a threshold or higher is not applied to the liquid crystal layer, the light from the backlight fails to transmit through the liquid crystal layer to give a black state. As a voltage of a threshold or higher is applied to the liquid crystal layer, the angle formed by the absorption axis of the pair of polarizing plates arranged in a crossed Nicols relationship, and the irradiation axis becomes, for example, 45°, so that the light from the backlight transmits through the liquid crystal layer to give a white state. The irradiation axis is a direction of oscillation of the polarized ultraviolet rays. By changing the irradiation direction of the polarized ultraviolet rays with respect to the substrates, it is possible to carry out an alignment dividing treatment.

The liquid crystal display device 100A is preferably in a transverse electric field display mode. Examples of the transverse electric field display mode include an IPS mode, an FFS mode, and an electrically controlled birefringence (ECB) mode.

### Embodiment 2

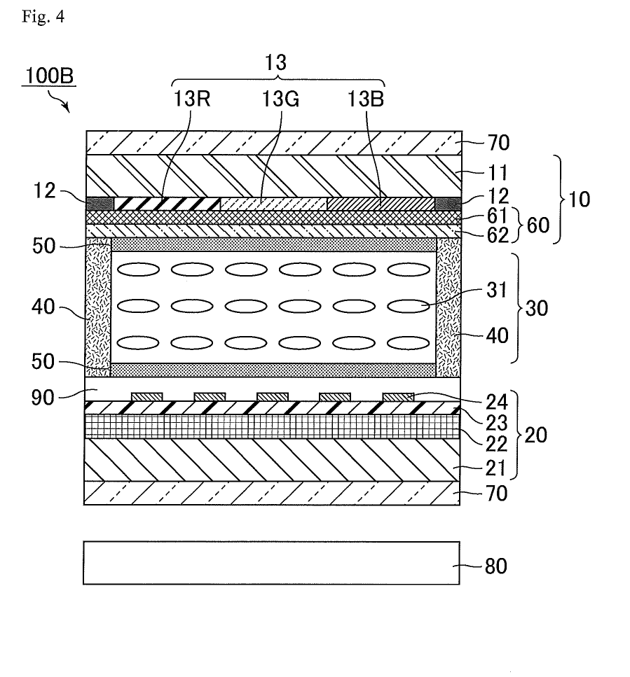

Referring to FIG. 4, a liquid crystal display device of Embodiment 2 is described. FIG. 4 is a schematic cross-sectional view of the liquid crystal display device according to Embodiment 2. A liquid crystal display device 100B of Embodiment 2 has an alignment film 90 between a substrate 20 not having a retardation layer 60, of a pair of substrates 10 and 20, and a liquid crystal layer 30. Also in the liquid crystal display device 100B, the substrate 10 having the retardation layer 60 does not have a conventional alignment film on a face on the side of the liquid crystal layer 30. Since Embodiment 2 is the same as Embodiment 1 except that the substrate 20 has the alignment film 90, description of each member is omitted.

Since the liquid crystal display device 100B does not have an alignment film on the retardation layer 60, deterioration in retardation of the retardation layer due to heating at the time of forming an alignment film does not occur. On the other hand, having the alignment film 90 on a face of the substrate not having the retardation layer 60 can further improve the alignment stability of the liquid crystal material. Further, having the alignment control layer 50 on the alignment film 90 can further improve the alignment stability of the liquid crystal material.

Examples of the alignment film 90 include, but are not particularly limited to, those generally used in the field of liquid crystal display device. Examples of the alignment film include a monolayer film or a multilayer film composed of polyimide, polyamic acid, polyamide, polymaleimide, polysiloxane, polysilsesquioxane, polyphosphazene, or a copolymer thereof, or a film of a silicon oxide formed by oblique deposition, capable of controlling alignment of a liquid crystal material. The alignment film is not limited to those having undergone an alignment treatment as long as an existing film material such as polyimide is applied. As the alignment treatment, for example, a rubbing method, and a photo-alignment method can be recited.

The sealing member 40 may have a width in a plan view of 0.4 mm or more and 5 mm or less. A more preferred lower limit of the width of the sealing member 40 is 0.8 mm, and a more preferred upper limit is 4 mm, and a further preferred upper limit is 2 mm.

### <Method for Producing Liquid Crystal Display Device of Embodiment 2>

A method for producing a liquid crystal display device of Embodiment 2 is the same as the method for producing a liquid crystal display device of Embodiment 1 except that the method includes a step of forming an alignment film on a face of the substrate in which a retardation layer is not formed, of the pair of the substrates prior to the step of forming a liquid crystal layer.

The method for producing a liquid crystal display device of Embodiment 2 includes a step of forming an alignment film prior to the step of forming a liquid crystal layer. For example, when the retardation layer 60 is formed in the substrate 10, the alignment film 90 is formed on a face of the substrate 20 by applying an alignment film material containing polyimide or the like or by vapor-depositing an alignment film material containing a silicon oxide (SiO) on a face of the substrate 20, and then conducting calcination, baking and so on. The aforementioned alignment treatment may be conducted for the alignment film 90.

While embodiments of the present invention have been described above, any individual matters that have been described are applicable to the entirety of the present invention.

For reference, a configuration of a liquid crystal display device 200 having an alignment film on the retardation layer is described by referring to FIG. 6. FIG. 6 is a schematic cross-sectional view of a liquid crystal display device having a conventional alignment film on a retardation layer. In a method for producing the liquid crystal display device 200, an alignment film 290 is formed on faces of a pair of substrates 210 and 220 before the substrate 210 having a retardation layer 260 and the substrate 220 are pasted together by a sealing member 240. The alignment film 290 can be formed, for example, by applying an alignment film material containing polyamic acid or the like on a face of each of the substrates 210 and 220, and conducting baking after the solvent in the alignment film material has volatilized by heating. Thereafter, the pair of substrates 210 and 220 each having the alignment film 290 formed on respective faces are pasted together by the sealing member 240 to form a liquid crystal layer 230. Accordingly, in the liquid crystal display device 200 having a conventional alignment film, retardation of the retardation layer 260 deteriorates due to heating at the time of forming the alignment film 290 on the retardation layer 260.

Hereinafter, the present invention is described in more detail based on examples and comparative examples. The examples, however, are not intended to limit the scope of the present invention.

### PRODUCTION EXAMPLE 1-1

### (Preparation of Liquid Crystal Composition)

A first monomer represented by the following Chemical formula (A-2-1) as a monomer for forming an alignment control layer was dissolved in a concentration of 1.0% by weight in a liquid crystal material having negative anisotropy of dielectric constant (Δε=−3.0) and a liquid crystal phase-isotropic phase transition point (T_{NI}) of 80° C., and then the resultant mixture was left to stand in an environment at 25° C. for 24 hours to dissolve the first monomer in the liquid crystal material.

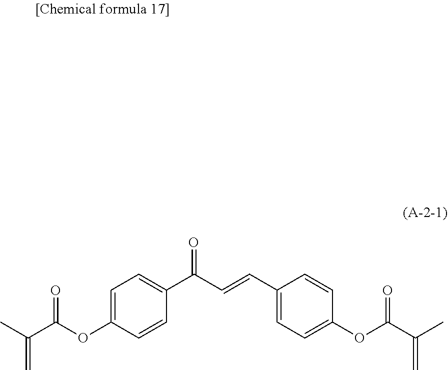 [SMILES: C=C(C)C(=O)Oc1ccc(/C=C/C(=O)c2ccc(OC(=O)C(=C)C)cc2)cc1]

### (Preparation of Liquid Crystal Panel)

A liquid crystal panel in FFS mode was actually prepared in the following manner. First, an ITO substrate in which a pixel electrode having an FFS electrode structure made of indium tin oxide (ITO), an insulating film and a common electrode are laminated, and a counter substrate not having an electrode were prepared. A sealing member (Photolec available from Sekisui Chemical Co., Ltd.) was applied to the ITO substrate, and the liquid crystal composition obtained in the above was dropped in a region surrounded by the sealing member, and then the counter substrate was pasted together to prepare a liquid crystal panel. As the sealing member, a sealing member cured by irradiation with ultraviolet rays and heating was used.

Subsequently, the liquid crystal panel was irradiated with linear polarized ultraviolet rays (wavelength of 300 to 380 nm) from the normal direction to the liquid crystal panel at 10 mW/cm² for 200 seconds (2 J/cm²) by using an extra-high pressure mercury lamp (available from USHIO INC.) while the liquid crystal panel was heated to a temperature of T_{NI} (90° C.) or higher, and thus an alignment keeping layer was formed and the sealing member was cured. Thereafter, the temperature of the liquid crystal panel was returned to room temperature to prepare a liquid crystal panel in FFS mode not having an alignment film in both of the substrates.

### PRODUCTION EXAMPLE 1-2

A liquid crystal panel in FFS mode of Production example 1-2 was prepared in the same manner as in Production example 1-1 except that for a liquid crystal material having negative anisotropy of dielectric constant (Δε=−3.0) and a T_{NI} of 75° C., a liquid crystal composition containing a first monomer represented by the following Chemical formula (A-1-1) as a monomer for forming an alignment control layer was used, and an alignment keeping layer was formed by irradiation with linear polarized ultraviolet rays while the liquid crystal panel was heated to a temperature of 100° C.

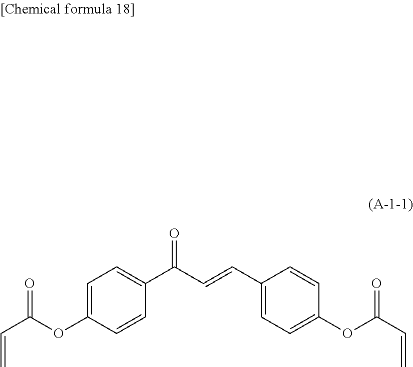 [SMILES: C=CC(=O)Oc1ccc(/C=C/C(=O)c2ccc(OC(=O)C=C)cc2)cc1]

### PRODUCTION EXAMPLE 1-3

A liquid crystal panel in FFS mode of Production example 1-3 was prepared in the same manner as in Production example 1-2 except that in the step of forming an alignment control layer, irradiation with the linear polarized ultraviolet rays was conducted at 25° C. without heating the liquid crystal panel.

### COMPARATIVE PRODUCTION EXAMPLE 1-1

A liquid crystal panel in FFS mode of Comparative production example 1-1 was prepared in the same manner as in Production example 1-1 except that as a monomer for forming an alignment control layer, a first monomer represented by Chemical formula (A-1-1) was used, and unpolarized ultraviolet rays were applied at 10 mW/cm² for 200 seconds (2 J/cm²) while the liquid crystal panel was heated to a temperature of 100° C.

### COMPARATIVE PRODUCTION EXAMPLE 1-2

A liquid crystal panel in FFS mode of Comparative production example 1-2 was prepared in the same manner as in Production example 1-2 except that in the liquid crystal material, 0.3% by weight of a monomer not having a chalconyl group represented by the following Chemical formula (F) was dissolved as a monomer for forming an alignment control layer. A saturated solution concentration of the monomer not having a chalconyl group represented by the following Chemical formula (F) is 0.35% by weight.

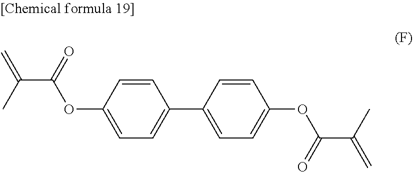 [SMILES: C=C(C)C(=O)Oc1ccc(-c2ccc(OC(=O)C(=C)C)cc2)cc1]

### <Measurement of Light Transmissive Intensity>

Light transmissive intensity in a black state and light transmissive intensity in a light transmissive state were measured for each liquid crystal panel in FFS mode prepared in Production examples 1-1 to 1-3, and Comparative production examples 1-1 and 1-2. On both sides of each liquid crystal panel, a pair of polarizing plates were arranged in a crossed Nicols relationship so that the absorption axes intersect each other at right angles, and the polarizing plates were arranged so that the angle formed by the absorption axis of the polarizing plates and the irradiation axis of the polarized ultraviolet rays was 0° or 90°, and light transmissive intensity in a black state was measured. Then, the pair of polarizing plates arranged in a crossed Nicols relationship were arranged so that the angle formed by the absorption axis of the pair of polarizing plates and the irradiation axis of the polarized ultraviolet rays was 45°, and light transmissive intensity in a light transmissive state was measured. From the obtained light transmissive intensity, a transmittance ratio was calculated by the following Formula (2). The results are shown in Table 1.

Transmittance ratio=Light transmissive intensity in black state/Light transmissive intensity in light transmissive intensity (2)

TABLE 1

| | Type of | Monomer content | | | Dose | Transmittance |
|---|---|---|---|---|---|---|
| | monomer | (wt %) | Heating | Irradiation light | (J/cm²) | ratio |
| Production | A-2-1 | 1.0 | Conducted | Polarized | 2 | 200 |
| example 1-1 | | | | ultraviolet rays | | |
| Production | A-1-1 | 1.0 | Conducted | Polarized | 2 | 200 |
| example 1-2 | | | | ultraviolet rays | | |
| Production | A-1-1 | 1.0 | Not conducted | Polarized | 2 | 10 |
| example 1-3 | | | | ultraviolet rays | | |
| Comparative | A-1-1 | 1.0 | Conducted | Unpolarized | 2 | 0.96 |
| production | | | | ultraviolet rays | | |
| example 1-1 | | | | | | |
| Comparative | F | 0.3 | Conducted | Polarized | 2 | 1.02 |
| production | | | | ultraviolet rays | | |
| example 1-2 | | | | | | |

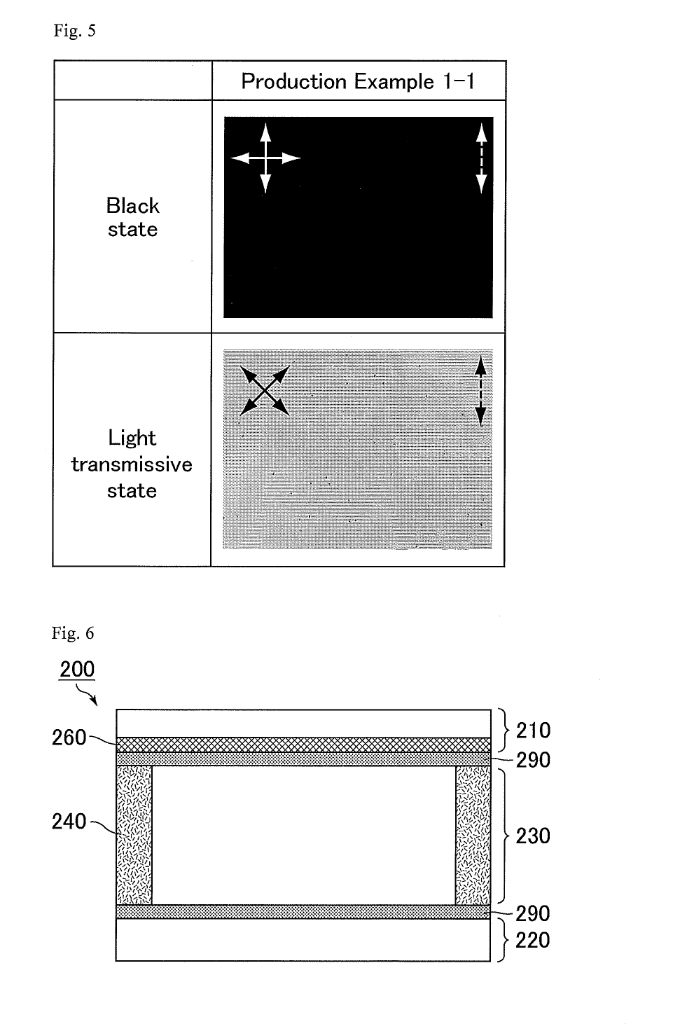

A black state and a light transmissive state of Production example 1-1 were observed with a scanning electron microscope. FIG. 5 shows photographs of a black state and a light transmission state of Production example 1-1. In FIG. 5, the solid double-pointed arrow indicates the absorption axis of the polarizing plates, and the dotted double-pointed arrow indicates the irradiation axis of the linear polarized ultraviolet rays.

Table 1 reveals that in Production examples 1-1 and 1-2, by irradiating a liquid crystal panel containing a liquid crystal composition containing the first monomer represented by Chemical formula (A-2-1) or (A-1-1) with polarized ultraviolet rays, an alignment control layer is formed, and horizontal alignment control is enabled. Focusing on Production example 1-1, as shown in FIG. 5, when the angle formed by the absorption axis of the polarizing plates and the irradiation axis of the linear polarized ultraviolet rays was 0° or 90°, the light did not transmit through the liquid crystal panel, and a black state was presented. When the angle formed by the absorption axis of the polarizing plates and the irradiation axis of the linear polarized ultraviolet rays was 45°, the light transmitted through the liquid crystal panel. According to the results of Production example 1-2 and Production example 1-3, it has been confirmed that by applying unpolarized ultraviolet rays while heating the liquid crystal panel at a temperature of T_{NI} or higher in the step of forming an alignment control layer, the horizontal alignability greatly improves. On the other hand, it has also been found that Comparative production example 1 in which unpolarized ultraviolet rays were applied, the light transmittance ratio was low, and horizontal alignment control is not enabled even when the first monomer represented by Chemical formula (A-1-1) is irradiated with the unpolarized ultraviolet rays. Comparative production example 1-2 in which a monomer not having a chalconyl group was used as a monomer for forming an alignment control layer was unaligned. From the above, it was confirmed that a liquid crystal display device in FFS mode can be prepared by using a first monomer represented by Chemical formula (A).

### PRODUCTION EXAMPLE 2-1

A liquid crystal panel in FFS mode of Production example 2-1 was prepared in the same manner as in Production example 1-1 except that the liquid crystal composition containing a liquid crystal material, a monomer for forming an alignment control layer, and a polymerization initiation polymer was used.

### (Preparation of Liquid Crystal Composition)

In a liquid crystal material (Δε=−3.0), T_{NI}=80° C.), 1.0% by weight of a first monomer represented by the following Chemical formula (A-2-2) as a monomer for forming an alignment control layer, and 0.1% by weight of a second monomer represented by the following Chemical formula (C-2-1) as a polymerization initiation monomer were dissolved, and then the resultant mixture was left to stand in an environment at 25° C. for 24 hours to dissolve the first monomer and the second monomer in the liquid crystal material.

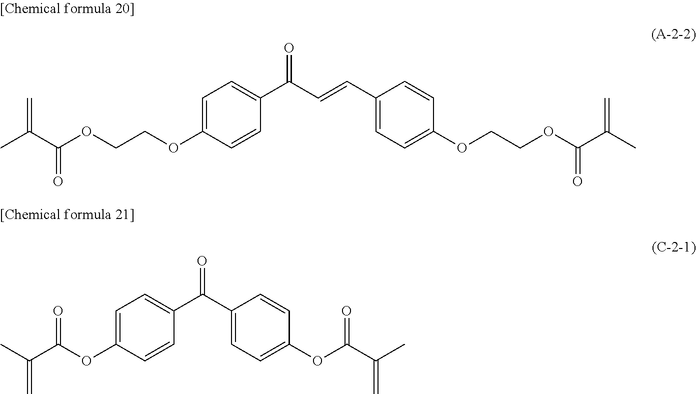

### PRODUCTION EXAMPLE 2-2

A liquid crystal panel in FFS mode of Production example 2-2 was prepared in the same manner as in Production example 1-1 except that the liquid crystal composition containing a liquid crystal material, a monomer for forming an alignment control layer, and a polymerization initiation polymer was used.

### (Preparation of Liquid Crystal Composition)

In a liquid crystal material (Δε=−3.0), T_{NI}=80° C.), 1.0% by weight of a first monomer represented by the following Chemical formula (A-2-2) as a monomer for forming an alignment control layer, and 0.1% by weight of a third monomer represented by the following Chemical formula (D-1-1) as a polymerization initiation monomer were dissolved, and then the resultant mixture was left to stand in an environment at 25° C. for 24 hours to dissolve the first monomer and the third monomer in the liquid crystal material.

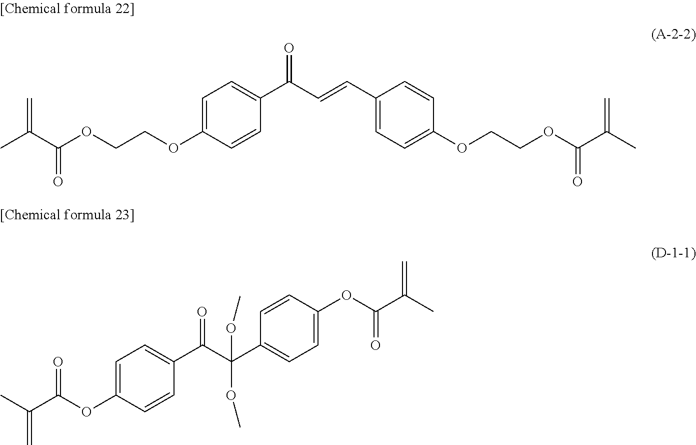

### COMPARATIVE PRODUCTION EXAMPLE 2

A liquid crystal panel in FFS mode of Comparative production example 2 was prepared in the same manner as in Example 1-1 except that a liquid crystal composition not containing a monomer for forming an alignment control layer was used.

### <Aging Test>

An aging test was conducted by placing a liquid crystal panel in FFS mode prepared in each of Production examples 1-1, 1-2, 2-1, 2-2 and Comparative production example 2 on an illuminating backlight, and leaving at a temperature of 30° C. for 100 hours, and measuring voltage holding ratios (VHR) before and after the test. VHR was measured in the condition of 1 V and 70° C. using a VHR measurement system Model 6254 available from TOYO Corporation. The results are shown in Table 2.

TABLE 2

| | |
|---|---|
| Monomer | VHR (%) |

| | Type of | content | Initial | After |
|---|---|---|---|---|
| | monomer | (wt %) | (0 hr) | 100 hrs |
| Production | A-2-1 | 1.0 | 96.2 | 93.4 |
| example 1-1 | | | | |
| Production | A-1-1 | 1.0 | 95.4 | 92.3 |
| example 1-2 | | | | |
| Production | A-2-2 | 1.0 | 97.7 | 95.3 |
| example 2-1 | C-2-1 | 0.1 | | |
| Production | A-2-2 | 1.0 | 98.0 | 95.9 |
| example 2-2 | D-1-1 | 0.1 | | |

| | | | |
|---|---|---|---|
| Comparative | Monomer not added | 91.5 | 83.6 |
| production | | | |
| example 2 | | | |

As shown in Table 2, high VHR was obtained in Production examples 1-1, 1-2, 2-1 and 2-2 in which a monomer for forming an alignment control layer was added to the liquid crystal composition, compared with Comparative production example 2 in which a monomer for forming an alignment control layer was not added. This is attributed to that since the monomer for forming an alignment control layer absorbs polarized ultraviolet rays applied into the liquid crystal material in an initial stage, degradation of the liquid crystal material due to irradiation with ultraviolet rays is suppressed. In comparison between Production example 1-1 and Production example 1-2, the first monomer represented by Chemical formula (A-2-1) showed higher VHRs before and after the aging test than the first monomer represented by Chemical formula (A-1-1). This is attributed to that photo deterioration such as ionization by degradation of monomer is less likely to occur by using a conjugate methacryl group rather than an acryl group as a polymerizable group. The results of Production examples 2-1 and 2-2 reveals that deterioration in VHR after the aging test can be suppressed by using the second monomer represented by Chemical formula (C-2-1) and the third monomer represented by Chemical formula (D-1-1) as the polymerization initiation monomer. This is attributed to that by using the polymerization initiation monomer, the forming speed of the alignment control layer further increases, and absorption of light by the alignment control layer itself reduces the dose of light to the liquid crystal layer, so that photo deterioration in the liquid crystal layer can be efficiently suppressed. From the above, it has been confirmed that a liquid crystal display device in FFS mode can also be prepared by using a combination of the first monomer represented by Chemical formula (A), the second monomer or the third monomer.

Since the horizontal alignment of the first monomer can be controlled, the first monomer is applicable also to a liquid crystal display devices in IPS mode and ECB mode which are transverse electric field display modes. Further, since it is possible to align the liquid crystal material horizontally without forming a conventional alignment film, retardation of the retardation layer will not deteriorate by heating at the time of forming an alignment film even when a substrate having a retardation layer on the side of the liquid crystal layer is used.

### EXAMPLE 1

Example 1 is a concrete example of a liquid crystal display device according to Embodiment 1. A liquid crystal display device in FFS mode was actually prepared in the following manner.

### (Formation of Retardation Layer)

On a substrate not having an electrode, an alignment layer composition containing polyamic acid represented by the following Chemical formula (G) was applied. Then, baking at 200° C. for 40 minutes was conducted to form a polyimide alignment layer on a face of the substrate. Then the alignment layer was subjected to a rubbing treatment. Then on a face of the alignment layer, a composition containing an acryl liquid crystal monomer (see Chemical formulas (E-1) to (E-14)) was applied, and irradiated with ultraviolet rays. In this manner, a counter substrate having a retardation layer in which a polymer of a liquid crystal monomer is laminated on an alignment layer was prepared. The obtained retardation layer had a retardation of 120 nm.

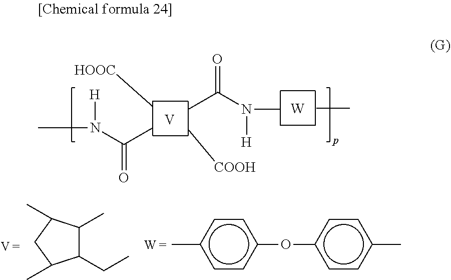

In the formula, p represents a degree of polymerization, and is an integer of 1 or more.

### (Preparation of Liquid Crystal Display Device)

An ITO substrate in which a pixel electrode having an FFS electrode structure made of indium tin oxide (ITO), an insulating film and a common electrode are laminated was prepared. A sealing member (Photolec available from Sekisui Chemical Co., Ltd.) was applied to the ITO substrate, and the liquid crystal composition obtained in Production example 1-1 was dropped in a region surrounded by the sealing member, and then the counter substrate was pasted together so that the retardation layer was on the side of the liquid crystal layer to prepare a liquid crystal panel having a retardation layer in the substrate.

Subsequently, the liquid crystal panel was irradiated with linear polarized ultraviolet rays (wavelength of 300 to 380 nm) from the normal direction to the liquid crystal panel at 10 mW/cm² for 200 seconds (2 J/cm²) while the liquid crystal panel was heated to a temperature of T_{NI} (90° C.) or higher, and thus an alignment keeping layer was formed and the sealing member was cured. Thereafter, the temperature of the liquid crystal panel was returned to room temperature to prepare a liquid crystal panel in FFS mode.

Then a pair of polarizing plates were pasted to the back face side (light incident face side of backlight) of the ITO substrate, and to the viewing face side (light outgoing face side of backlight) of the counter substrate so that the polarizing axes have the crossed Nicols relationship, and further, a backlight was attached on the back face side of the ITO substrate, and thus a liquid crystal display device of Example 1 was completed. Display was made by using a liquid crystal display device of Example 1, and visibility determined outdoors was excellent. The visibility was determined depending on whether an image can be recognized outdoors on a sunny day.

### EXAMPLE 2

Example 2 is a concrete example of a liquid crystal display device according to Embodiment 2. A liquid crystal display device of Example 2 was prepared in the same manner as in Example 1 except that an alignment film was formed in the ITO substrate.

### (Formation of Alignment Film)

An ITO substrate in which a pixel electrode having an FFS electrode structure, an insulating film, and a common electrode were laminated was prepared, and on a face of the

ITO substrate, an alignment film material containing polyamic acid was applied by printing. Subsequently, calcination was conducted on a hot plate at 90° C. for 5 minutes, and then baking was conducted in an oven at 230° C. for 40 minutes. Then the alignment film was subjected to a rubbing treatment.

### (Preparation of Liquid Crystal Display Device)

In the same manner as in Example 1, a retardation layer was formed in a substrate not having an electrode to prepare a counter substrate. A sealing member (Photolec available from Sekisui Chemical Co., Ltd.) was applied to the ITO substrate in which the alignment film was formed, and the liquid crystal composition obtained in Production example 1-1 was dropped in a region surrounded by the sealing member, and then the counter substrate was pasted together so that the retardation layer was on the side of the liquid crystal layer to prepare a liquid crystal panel having a retardation layer in the substrate.

Subsequently, the liquid crystal panel was irradiated with linear polarized ultraviolet rays (wavelength of 300 to 380 nm) from the normal direction to the liquid crystal panel at 10 mW/cm² for 500 seconds (5 J/cm²) while the liquid crystal panel was heated to a temperature of T_{NI} (90° C.) or higher, and thus an alignment keeping layer was formed and the sealing member was cured. Irradiation with the linear polarized ultraviolet rays was conducted so that the orientation in which the liquid crystal material aligns by the rubbing treatment on the alignment film, and the orientation in which the liquid crystal material aligns by irradiation with the linear polarized ultraviolet rays were parallel with each other. Thereafter, the temperature of the liquid crystal panel was returned to room temperature to prepare a liquid crystal panel in FFS mode.

Then in the same manner as in Example 1, a pair of polarizing plates were pasted, and a backlight was attached to complete the liquid crystal display device of Example 2. The retardation layer had a retardation of 120 nm. Display was made by using a liquid crystal display device of Example 2, and visibility determined outdoors was excellent.

### EXAMPLE 3

Example 3 is a concrete example of a liquid crystal display device according to Embodiment 1. A liquid crystal display device of Example 3 was prepared in the same manner as in Example 1 except that a photo-alignment treatment was conducted on the alignment layer, and the composition of the liquid crystal composition was different.

### (Preparation of Liquid Crystal Composition)

A first monomer represented by Chemical formula (A-1-1) as a monomer for forming an alignment control layer was dissolved in a concentration of 1.0% by weight in a liquid crystal material having positive anisotropy of dielectric constant (Δε=3.0) and T_{NI} of 95° C., and then the resultant mixture was left to stand in an environment at 25° C. for 24 hours to dissolve the first monomer in the liquid crystal material.

### (Formation of Retardation Layer)

On a substrate not having an electrode, an alignment layer composition containing polyamic acid having a photo functional group was applied. Then, baking at 200° C. for 40 minutes was conducted to form a polyimide alignment layer on a face of the substrate. Then the alignment layer was subjected to a photo-alignment treatment. Next, a counter substrate having a retardation layer in which a polymer of a liquid crystal monomer is laminated on an alignment layer was prepared in the same manner as in Example 1. The obtained retardation layer had a retardation of 130 nm.

### (Preparation of Liquid Crystal Display Device)

An ITO substrate in which a pixel electrode having an FFS electrode structure, an insulating film and a common electrode are laminated was prepared, and on the ITO substrate, a sealing member (Photolec available from Sekisui Chemical Co., Ltd.) was applied, and the liquid crystal composition obtained in the above was dropped in a region surrounded by the sealing member, and then the counter substrate was pasted together so that the retardation layer was on the side of the liquid crystal layer to prepare a liquid crystal panel having a retardation layer in the substrate.

Subsequently, the liquid crystal panel was irradiated with linear polarized ultraviolet rays (wavelength of 300 to 380 nm) from the normal direction to the liquid crystal panel at 10 mW/cm² for 200 seconds (2 J/cm²) while the liquid crystal panel was heated to a temperature of T_{NI} (100° C.) or higher, and thus an alignment keeping layer was formed and the sealing member was cured. Thereafter, the temperature of the liquid crystal panel was returned to room temperature to prepare a liquid crystal panel in FFS mode.

Then in the same manner as in Example 1, a pair of polarizing plates were pasted, and a backlight was attached to complete the liquid crystal display device of Example 3. Display was made by using a liquid crystal display device of Example 3, and visibility determined outdoors was excellent.

### EXAMPLE 4

Example 4 is a concrete example of a liquid crystal display device according to Embodiment 2. In Example 4, a liquid crystal display device of Example 4 was prepared in the same manner as in Example 2 except that the liquid crystal composition used in Production example 2-1 was used.

The retardation layer had a retardation of 120 nm. Display was made by using a liquid crystal display device of Example 4, and visibility determined outdoors was excellent.

### EXAMPLE 5

Example 5 is a concrete example of a liquid crystal display device according to Embodiment 2. In Example 5, a liquid crystal display device of Example 5 was prepared in the same manner as in Example 2 except that the liquid crystal composition used in Production example 2-2 was used. The retardation layer had a retardation of 120 nm. Display was made by using a liquid crystal display device of Example 5, and visibility determined outdoors was excellent.

### COMPARATIVE EXAMPLE 1

In Comparative example 1, a liquid crystal display device of Example 5 was prepared in the same manner as in Example 2 except that an alignment film was formed on the retardation layer. First, in the same manner as in Example 1, a retardation layer was formed in a substrate not having an electrode. Next, on a face of the substrate in which the retardation layer was formed, and a face of the ITO substrate, an alignment film material containing polyamic acid was applied by printing. Subsequently, calcination was conducted on a hot plate at 90° C. for 5 minutes, and then baking was conducted in an oven at 230° C. for 40 minutes, and then the alignment film was subjected to a rubbing treatment.

Then, in the same manner as in Example 2, a liquid crystal panel was prepared, and heating of the liquid crystal panel, and irradiation with linear polarized ultraviolet rays were conducted. A pair of polarizing plates were pasted, and a backlight was attached to complete the liquid crystal display device of Comparative example 1. The retardation of the retardation layer significantly decreased to 55 nm, from 120 nm in Example 2. Display was made by using a liquid crystal display device of Comparative example 1, and visibility was examined outdoors. Outside light was reflected, and visibility deteriorated compared with Example 2.

### [Additional Remarks]

One aspect of the present invention may be a liquid crystal display device including a pair of substrates, a liquid crystal layer that is sandwiched between the pair of substrates and contains a liquid crystal material, and an alignment control layer that is in contact with the liquid crystal layer, at least one of the pair of substrates including a retardation layer on its liquid crystal layer side, the alignment control layer aligning the liquid crystal material in a direction horizontal to faces of the substrates, and containing a polymer containing at least a unit derived from a first monomer represented by the following Chemical formula (1). The liquid crystal display device can suppress reflection of outside light and improve the visibility by having a retardation layer. Since the first monomer represented by the following Chemical formula (1) has a chalconyl group, and is capable of absorbing the polarized ultraviolet rays to express the alignment restraining force, the intensity of light irradiation applied to the liquid crystal layer can be made lower compared with irradiation with unpolarized light.

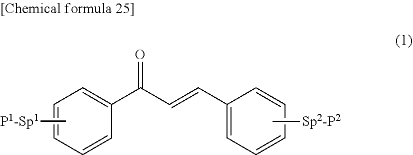

In the formula, P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

In one aspect of the present invention, the first monomer may be a monomer represented by either one of the following Chemical formulas (2-1) to (2-5). The monomers represented by the following Formulas (2-1) and (2-2) polymerize without necessity of a polymerization initiator or a polymerization initiation monomer, and can form an alignment control layer. In the monomers represented by Chemical formulas (2-3), (2-4), and (2-5), an alkyl group is introduced between a chalconyl group and a polymerizable group, and the molecular structure is flexible. Therefore, an alignment control layer having more excellent alignability can be obtained.

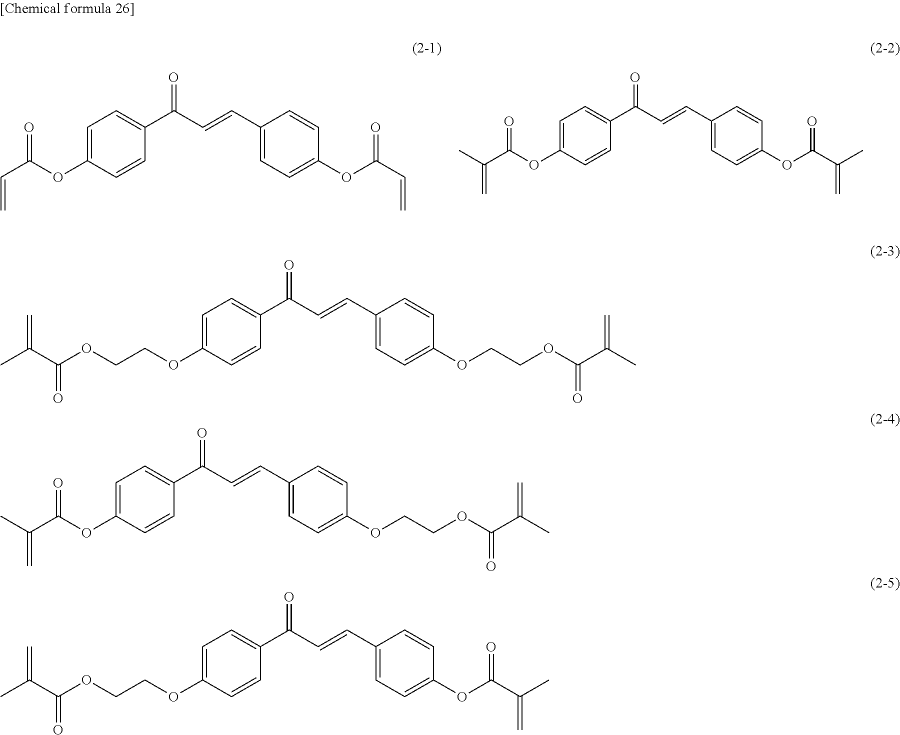

In one aspect of the present invention, the retardation layer may have an in-plane phase difference of 100 to 160 nm. By setting the phase difference within the range of 100 to 160 nm, it is possible to effectively suppress reflection of visible light contained in outside light.

In one aspect of the present invention, the retardation layer may be a laminate of an alignment layer and a polymer of a liquid crystal monomer. The liquid crystal monomer may be an acryl monomer or a methacryl monomer.

In one aspect of the present invention, the polymer may further contain a unit derived from a second monomer represented by the following Chemical formula (3). Since the second monomer is capable of improving the polymerization speed of the first monomer, it is possible to reduce the intensity of light irradiation applied to the liquid crystal layer at the time of forming the alignment control layer.

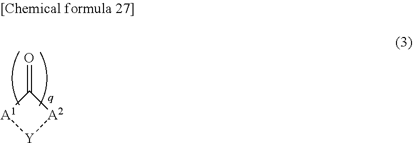

In the formula, A¹ and A² are the same as or different from each other, and each represent a benzene ring, a biphenyl ring, a linear or branched C1-C12 alkyl group, or a linear or branched C1-C12 alkenyl group,

either one of A¹ and A² is a benzene ring or a biphenyl ring,

at least one selected from A¹ and A² contains an -Sp³-P³ group, a hydrogen atom in each of A¹ and A² may be replaced by an -Sp³-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group,

two adjacent hydrogen atoms in each of A¹ and A² may each be replaced by a linear or branched C1-C12 alkylene group, a linear or branched C1-C12 alkenylene group, or a linear or branched C1-C12 aralkyl group to form a cyclic structure,

a hydrogen atom of an alkyl group, an alkenyl group, an alkylene group, an alkenylene group or an aralkyl group of each of A¹ and A² may be replaced by an -Sp³-P³ group,

a —CH₂— group of an alkyl group, an alkenyl group, an alkylene group, an alkenylene group or an aralkyl group of each of A¹ and A² may be replaced by an —O—group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, —C≡C— group, a —CH═CH—COO— group, or an —OCO—CH═CH— group as long as an oxygen atom, a sulfur atom, and a nitrogen atom are not adjacent to one another,

P³ represents a polymerizable group,

Sp³ represents a linear, branched, or cyclic C1-C6 alkylene group, a linear, branched, or cyclic C1-C6 alkyleneoxy group, or a direct bond,

q is 1 or 2,

the dotted line part connecting A¹ and Y, and the dotted line part connecting A² and Y indicate that a bond via Y may exist between A¹ and A², and

Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

In one aspect of the present invention, the polymer may further contain a unit derived from a third monomer represented by the following Chemical formula (4). Since the third monomer is capable of improving the polymerization speed of the first monomer, it is possible to reduce the intensity of light irradiation applied to the liquid crystal layer at the time of forming the alignment control layer.

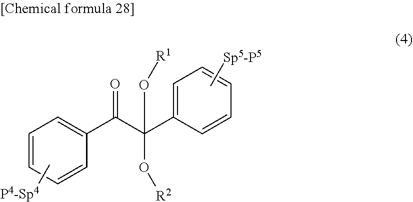

In the formula, R¹ and R² are the same as or different from each other, and each represent a linear or branched C1-C4 alkyl group, or a linear or branched C1-C4 alkenyl group,

P⁴ and P⁵ are the same as or different from each other, and each represent an acryloyloxy group, a methacryloyloxy group, an acryloylamino group, a methacryloylamino group, a vinyl group, or a vinyloxy group, and

Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

In one aspect of the present invention, an alignment film may be provided between the liquid crystal layer and the substrate not including the retardation layer of the pair of substrates. By having the alignment film, it is possible to improve the alignment stability of the liquid crystal material.

In one aspect of the present invention, the liquid crystal material may have negative anisotropy of dielectric constant or may have positive anisotropy of dielectric constant.

In one aspect of the present invention, the liquid crystal display device may be in a transverse electric field display mode.

Another aspect of the present invention may be a method for producing a liquid crystal display device, including a step of forming a retardation layer in at least one of a pair of substrates, a step of sealing a liquid crystal composition containing a liquid crystal material and at least one type of monomer between the pair of substrates to form a liquid crystal layer, and a step of irradiating the liquid crystal layer with polarized ultraviolet rays to form an alignment control layer by polymerization of the at least one type of monomer at an interface between the pair of substrates and the liquid crystal layer, the at least one type of monomer containing a first monomer represented by the following Chemical formula (1), the alignment control layer aligning the liquid crystal material in a direction horizontal to faces of the substrates.

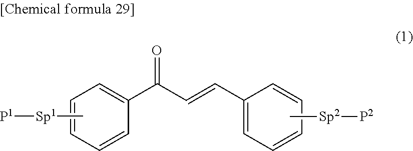

In the formula, P¹ and P² are the same as or different from each other, and each represent an acryloyloxy group, a methacryloyloxy group, an acryloylamino group, a methacryloylamino group, a vinyl group, or a vinyloxy group, and

Sp¹ and Sp² are the same as or different from each other, and each represent a linear, branched, or cyclic C1-C6 alkylene group, a linear, branched, or cyclic C1-C6 alkyleneoxy group, or a direct bond.

In another aspect of the present invention, the first monomer may be a monomer represented by any one of the following Chemical formulas (2-1) to (2-5).

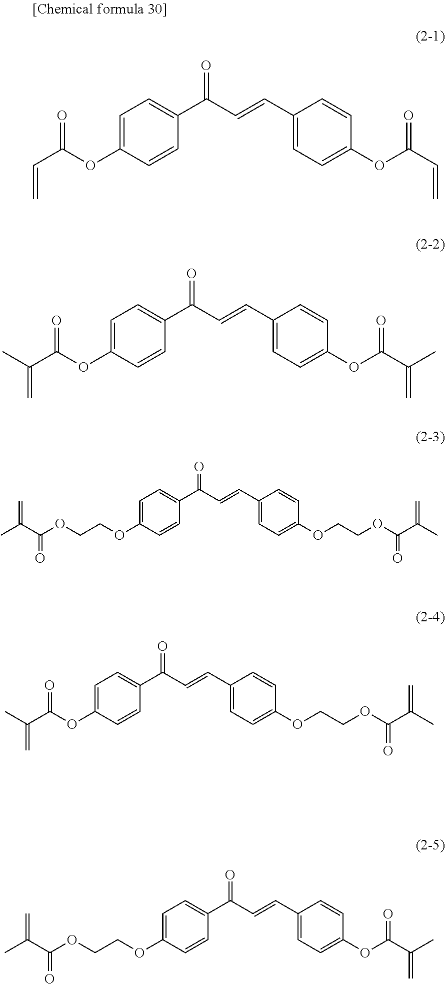

In another aspect of the present invention, in the step of forming a retardation layer, an alignment layer may be formed on a face of at least one of the substrates, a composition containing a liquid crystal monomer may be applied on the alignment layer, and the liquid crystal monomer may be polymerized. The liquid crystal monomer may be an acryl monomer or a methacryl monomer.

In another aspect of the present invention, the at least one type of monomer may contain a second monomer represented by Chemical formula (3).

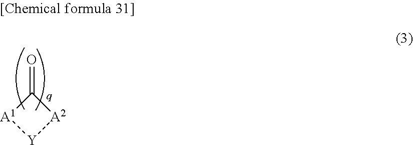

In the formula, A¹ and A² are the same as or different from each other, and each represent a benzene ring, a biphenyl ring, a linear or branched C1-C12 alkyl group, or a linear or branched C1-C12 alkenyl group,

either one of A¹ and A² is a benzene ring or a biphenyl ring,

at least one selected from A¹ and A² contains an -Sp³-P³ group,

a hydrogen atom in each of A¹ and A² may be replaced by an -Sp^{a}-P³ group, a halogen atom, a —CN group, an —NO₂ group, an —NCO group, an —NCS group, an —OCN group, an —SCN group, an —SF₅ group, a linear or branched C1-C12 alkyl group, a linear or branched C1-C12 alkenyl group, or a linear or branched C1-C12 aralkyl group,

two adjacent hydrogen atoms in each of A¹ and A² may each be replaced by a linear or branched C1-C12 alkylene group, a linear or branched C1-C12 alkenylene group, or a linear or branched C1-C12 aralkyl group to form a cyclic structure,

a hydrogen atom of an alkyl group, an alkenyl group, an alkylene group, an alkenylene group or an aralkyl group of each of A¹ and A² may be replaced by an -Sp^{a}-P³ group,

a —CH₂— group of an alkyl group, an alkenyl group, an alkylene group, an alkenylene group or an aralkyl group of A¹ and A² may be replaced by an —O—group, an —S— group, an —NH— group, a —CO— group, a —COO— group, an —OCO—group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,

P³ represents a polymerizable group,

Sp³ represents a linear, branched, or cyclic C1-C6 alkylene group, a linear, branched, or cyclic C1-C6 alkyleneoxy group, or a direct bond,

q is 1 or 2,

the dotted line part connecting A¹ and Y, and the dotted line part connecting A² and Y indicate that a bond via Y may exist between A¹ and A², and

Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

In another aspect of the present invention, the at least one type of monomer may contain a third monomer represented by Chemical formula (4).

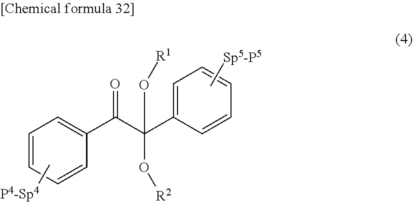

In the formula, R¹ and R² are the same as or different from each other, and each represent a linear or branched C1-C4 alkyl group, or a linear or branched C1-C4 alkenyl group,

P⁴ and P⁵ are the same as or different from each other, and each represent an acryloyloxy group, a methacryloyloxy group, an acryloylamino group, a methacryloylamino group, a vinyl group or a vinyloxy group, and

Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

In another aspect of the present invention, in the step of forming an alignment control layer, polarized ultraviolet rays may be applied while the liquid crystal layer is heated at a temperature of a nematic phase-isotropic phase transition point of the liquid crystal material or higher and lower than 200° C.

In another aspect of the present invention, prior to the step of forming a liquid crystal layer, a step of forming an alignment film on a face of the substrate without a retardation layer formed thereon of the pair of substrates may be provided.

These aspects of the present invention described above may appropriately be combined within the spirit of the present invention.

### REFERENCE SIGNS LIST

10, 20, 210, 220: substrate
11, 21: transparent substrate
12: black matrix
13: color filter
22: common electrode
23: insulating layer
24: pixel electrode
30, 230: liquid crystal layer
31: liquid crystal material
40, 240: sealing member
50: alignment control layer
60, 260: retardation layer
61: alignment layer
62: polymer of liquid crystal monomer
70: polarizing plate
80: backlight
90, 290: alignment film
100A, 100B, 200: liquid crystal display device

1. A liquid crystal display device comprising:
a pair of substrates;
a liquid crystal layer that is sandwiched between the pair of substrates and contains a liquid crystal material; and
an alignment control layer that is in contact with the liquid crystal layer, at least one of the pair of substrates including a retardation layer on its liquid crystal layer side,
the alignment control layer aligning the liquid crystal material in a direction horizontal to faces of the substrates, and containing a polymer containing at least a unit derived from a first monomer represented by the following Chemical formula (1): 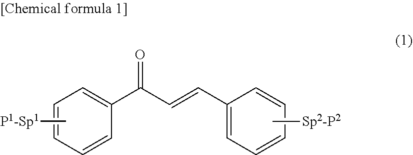
wherein P¹ and P² are the same as or different from each other, and each represent an acryloyloxy group, a methacryloyloxy group, an acryloylamino group, a methacryloylamino group, a vinyl group, or a vinyloxy group, and
Sp¹ and Sp² are the same as or different from each other, and each represent a linear, branched, or cyclic C1-C6 alkylene group, a linear, branched, or cyclic C1-C6 alkyleneoxy group, or a direct bond.

2. The liquid crystal display device according to claim 1,
wherein the first monomer is a monomer represented by any one of the following Chemical formulas (2-1) to (2-5):

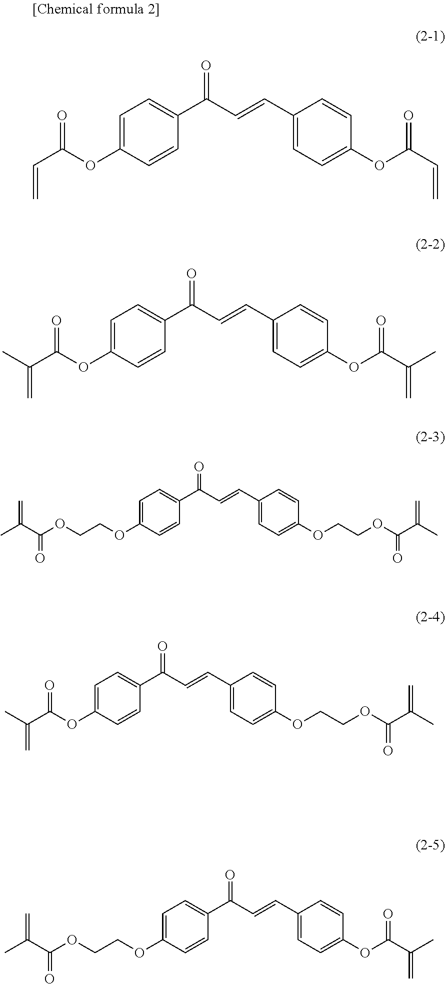

3. The liquid crystal display device according to claim 1,
wherein the retardation layer has an in-plane phase difference of 100 to 160 nm.

4. The liquid crystal display device according to claim 1,
wherein the retardation layer is a laminate of an alignment layer and a polymer of a liquid crystal monomer.

5. The liquid crystal display device according to claim 4,
wherein the liquid crystal monomer is an acryl monomer or a methacryl monomer.

6. The liquid crystal display device according to claim 1,
wherein the polymer further contains a unit derived from a second monomer represented by the following Chemical formula (3): 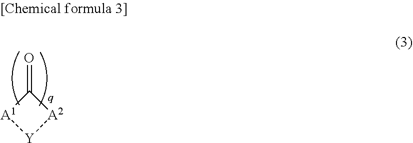
wherein A¹ and A² are the same as or different from each other, and each represent a benzene ring, a biphenyl ring, a linear or branched C1-C12 alkyl group, or a linear or branched C 1-C 12 alkenyl group,
either one of A¹ and A² is a benzene ring or a biphenyl ring,
at least one selected from A¹ and A² contains an -Sp³-P³ group,
a hydrogen atom in each of A¹ and A² may be replaced by an -Sp³-P³ group, a halogen atom, a —CN group, an —NO2 group, an —NCO group, an —NCS group, an —OCN group, an —SCN group, an —SFs group, a linear or branched C1-C12 alkyl group, a linear or branched C1-C12 alkenyl group, or a linear or branched C1-C12 aralkyl group,
two adjacent hydrogen atoms in each of A¹ and A² may each be replaced by a linear or branched C1-C12 alkylene group, a linear or branched C1-C12 alkenylene group, or a linear or branched C1-C12 aralkyl group to form a cyclic structure,
a hydrogen atom of an alkyl group, an alkenyl group, an alkylene group, an alkenylene group or an aralkyl group of each of A¹ and A² may be replaced by an -Sp³-P³ group,
a —CH₂— group of an alkyl group, an alkenyl group, an alkylene group, an alkenylene group, or an aralkyl group of each of A¹ and A² may be replaced by an —O—group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, a —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,
P³ represents a polymerizable group,
Sp³ represents a linear, branched, or cyclic C1-C6 alkylene group, a linear, branched, or cyclic C1-C6 alkyleneoxy group, or a direct bond,
q is 1 or 2,
the dotted line part connecting A¹ and Y, and the dotted line part connecting A² and Y indicate that a bond via Y may exist between A¹ and A², and
Y represents a —CH₂— group, a —CH₂CH₂— group, a —CH═CH— group, an —O—group, an —S— group, an —NH— group, an —N(CH₃)— group, an —N(C₂H₅)— group, an —N(C₃H₇)— group, an —N(C₄H₉)— group, an —OCH₂— group, a —CH₂O— group, an —SCH₂— group, a —CH₂S— group, or a direct bond.

7. The liquid crystal display device according to claim 1,
wherein the polymer further contains a unit derived from a third monomer represented by the following Chemical formula (4): 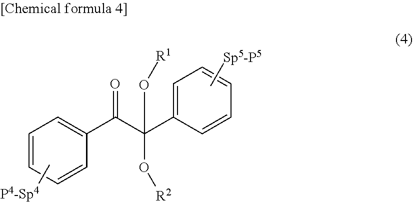
wherein R¹ and R² are the same as or different from each other, and each represent a linear or branched C1-C4 alkyl group, or a linear or branched C1-C4 alkenyl group,
P⁴ and P⁵ are the same as or different from each other, and each represent an acryloyloxy group, a methacryloyloxy group, an acryloylamino group, a methacryloylamino group, a vinyl group, or a vinyloxy group, and
Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

8. The liquid crystal display device according to claim 1, which includes an alignment film between the liquid crystal layer and a substrate not including the retardation layer of the pair of substrates.

9. The liquid crystal display device according to claim 1,
wherein the liquid crystal material has negative anisotropy of dielectric constant.

10. The liquid crystal display device according to claim 1,
wherein the liquid crystal material has positive anisotropy of dielectric constant.

11. The liquid crystal display device according to claim 1,
wherein the liquid crystal display device is in a transverse electric field display mode.

12. A method for producing a liquid crystal display device, comprising:
a step of forming a retardation layer in at least one of a pair of substrates;
a step of sealing a liquid crystal composition containing a liquid crystal material and at least one type of monomer between the pair of substrates to form a liquid crystal layer; and
a step of irradiating the liquid crystal layer with polarized ultraviolet rays to form an alignment control layer by polymerization of the at least one type of monomer at an interface between the pair of substrates and the liquid crystal layer,
the at least one type of monomer containing a first monomer represented by the following Chemical formula (1),
the alignment control layer aligning the liquid crystal material in a direction horizontal to faces of the substrates, 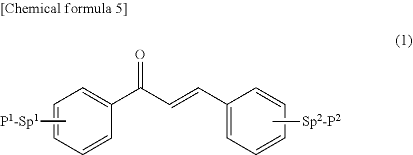
wherein P¹ and P² are the same as or different from each other, and each represent an acryloyloxy group, a methacryloyloxy group, an acryloylamino group, a methacryloylamino group, a vinyl group or a vinyloxy group, and
Sp¹ and Sp² are the same as or different from each other, and each represent a linear, branched, or cyclic C1-C6 alkylene group, a linear, branched, or cyclic C1-C6 alkyleneoxy group, or a direct bond.

13. The method for producing a liquid crystal display device according to claim 12,
wherein the first monomer is a monomer represented by any one of the following Chemical formulas (2-1) to (2-5):

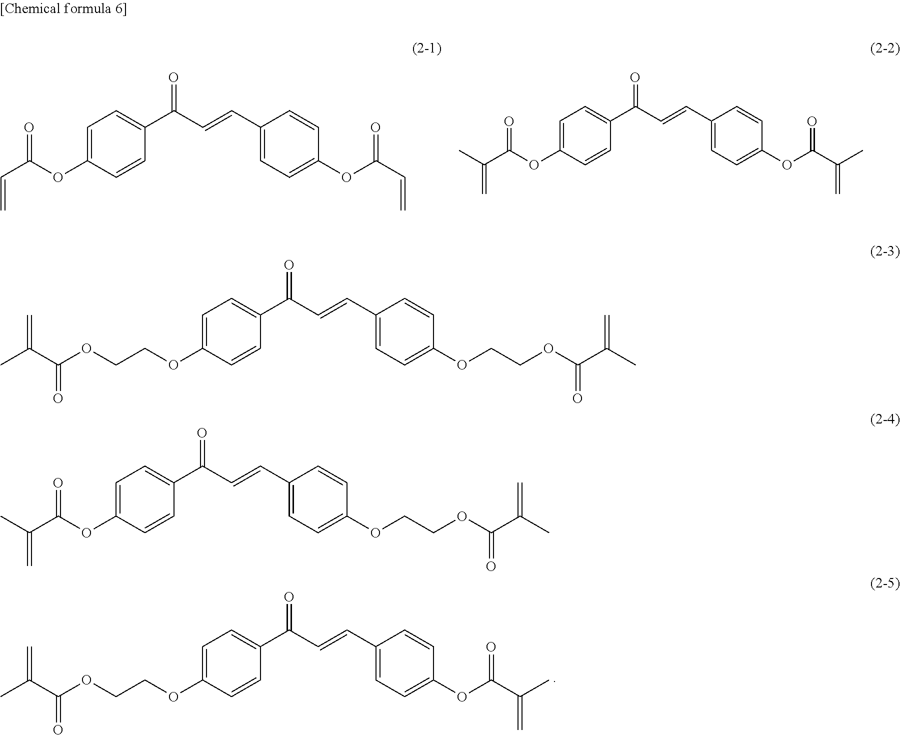

14. The method for producing a liquid crystal display device according to claim 12,
wherein in the step of forming a retardation layer, an alignment layer is formed on a face of at least one of the substrates, a composition containing a liquid crystal monomer is applied on the alignment layer, and the liquid crystal monomer is polymerized.

15. The method for producing a liquid crystal display device according to claim 14,
wherein the liquid crystal monomer is an acryl monomer or a methacryl monomer.

16. The method for producing a liquid crystal display device according to claim 12,
wherein the at least one type of monomer contains a second monomer represented by the following Chemical formula (3): 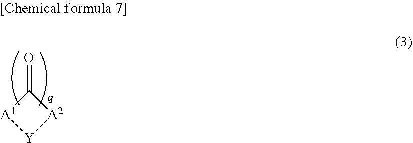
wherein A¹ and A² are the same as or different from each other, and each represent a benzene ring, a biphenyl ring, a linear or branched C1-C12 alkyl group, or a linear or branched C1-C12 alkenyl group,
either one of A¹ and A² is a benzene ring or a biphenyl ring,
at least one selected from A¹ and A² contains an -Sp³-P³ group,
a hydrogen atom in each of A¹ and A² may be replaced by an -Sp³-P³ group, a halogen atom, a —CN group, an —NO₂ group, an —NCO group, an —NCS group, an —OCN group, an —SCN group, an —SFs group, a linear or branched C1-C12 alkyl group, a linear or branched C1-C12 alkenyl group, or a linear or branched C1-C12 aralkyl group,
two adjacent hydrogen atoms in each of A¹ and A² may each be replaced by a linear or branched C1-C12 alkylene group, a linear or branched C1-C12 alkenylene group, or a linear or branched C1-C12 aralkyl group to form a cyclic structure,
a hydrogen atom of an alkyl group, an alkenyl group, an alkylene group, an alkenylene group or an aralkyl group of each of A¹ and A² may be replaced by an -Sp^{a}-P³ group,
a —CH₂— group of an alkyl group, an alkenyl group, an alkylene group, an alkenylene group, or an aralkyl group of each of A¹ and A² may be replaced by an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CH₂CF₂— group, a —CF₂CH₂— group, a —CF₂CF₂— group, a —CH═CH— group, a —CF═CF— group, a —C≡C— group, a —CH═CH—COO— group, or an —OCO—CH═CH— group as long as an oxygen atom, a sulfur atom, and a nitrogen atom are not adjacent to one another,
P³ represents a polymerizable group,
Sp³ represents a linear, branched, or cyclic C1-C6 alkylene group, a linear, branched, or cyclic C1-C6 alkyleneoxy group, or a direct bond,
q is 1 or 2,
the dotted line part connecting A¹ and Y, and the dotted line part connecting A² and Y indicate that a bond via Y may exist between A¹ and A², and
Y represents a —CH₂— group, a —CH₂CH₂— group, a —CH═CH— group, an —O— group, an —S— group, an —NH— group, an —N(CH₃)— group, an —N(C₂H₅)— group, an —N(C₃H₇)— group, an —N(C₄h₉)— group, an —OCH₂— group, a —CH₂O— group, an —SCH₂— group, a —CH₂S— group, or a direct bond.

17. The method for producing a liquid crystal display device according to claim 12,
wherein the at least one type of monomer contains a third monomer represented by the following Chemical formula (4): 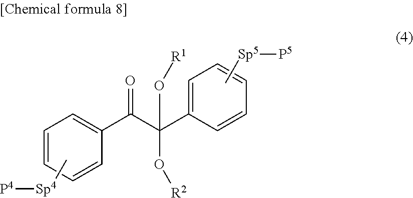
wherein R¹ and R² are the same as or different from each other, and each represent a linear or branched C1-C4 alkyl group, or a linear or branched C1-C4 alkenyl group,
P⁴ and P⁵ are the same as or different from each other, and each represent an acryloyloxy group, a methacryloyloxy group, an acryloylamino group, a methacryloylamino group, a vinyl group or a vinyloxy group, and
Sp⁴ and Sp⁵ are the same as or different from each other, and each represent a linear, branched, or cyclic C1-C6 alkylene group, a linear, branched, or cyclic C1-C6 alkyleneoxy group, a linear, branched, or cyclic C1-C6 alkylenecarbonyloxy group, or a direct bond.

18. The method for producing a liquid crystal display device according to claim 12,
wherein in the step of forming an alignment control layer, polarized ultraviolet rays are applied while the liquid crystal layer is heated at a temperature of a nematic phase-isotropic phase transition point of the liquid crystal material or higher and lower than 200° C.

19. The method for producing a liquid crystal display device according to claim 12, comprising a step of forming an alignment film on a face of the substrate without a retardation layerformed thereon of the pair of the substrates prior to the step of forming a liquid crystal layer.
